(19) United States
(12) Patent Application Publication
(10) Pub. No.: US 2018/0040107 A1
(43) Pub. Date: Feb. 8, 2018

(54) IMAGE PROCESSING DEVICE, IMAGING DEVICE, IMAGE PROCESSING METHOD, AND PROGRAM

(71) Applicant: FUJIFILM Corporation, Tokyo (JP)

(72) Inventors: Kenkichi HAYASHI, Saitama-shi (JP); Junichi TANAKA, Saitama-shi (JP); Yousuke NARUSE, Saitama-shi (JP); Masahiko SUGIMOTO, Saitama-shi (JP)

(73) Assignee: FUJIFILM Corporation, Tokyo (JP)

(21) Appl. No.: 15/788,996

(22) Filed: Oct. 20, 2017

Related U.S. Application Data
(63) Continuation of application No. PCT/JP2016/062171, filed on Apr. 15, 2016.

(30) Foreign Application Priority Data
Apr. 23, 2015 (JP) 2015-088230

(51) Int. Cl. G06T 5/00; H04N 5/232; H04N 5/33; G02B 5/20

(52) U.S. Cl. CPC G06T 5/003; G02B 5/208; G06T 5/007; H04N 5/23245; H04N 5/332; G06T 2207/10024; G06T 2207/10048; G06T 2207/20192

(57) ABSTRACT

The present invention provides an image processing device, an imaging device, an image processing method, and a program capable of effectively performing a point image restoration process on a visible light image and a near-infrared ray image, and improving accuracy of a point image restoration process. An image processing device according to an aspect of the present invention includes an image input unit that receives first image data indicating a visible light image imaged with sensitivity to a visible light wavelength band by using an optical system and second image data indicating a near-infrared ray image imaged with sensitivity to a near-infrared ray wavelength band by using the optical system, a first restoration processing unit that performs a first restoration process of performing phase correction and amplitude restoration on the first image data, and a second restoration processing unit that performs a second restoration process of performing amplitude restoration without phase correction on the second image data.

### CROSS-REFERENCE TO RELATED APPLICATIONS

The present application is a Continuation of PCT International Application No. PCT/JP2016/062171 filed on Apr. 15, 2016 claiming priority under 35 U.S.C §119(a) to Japanese Patent Application No. 2015-088230 filed on Apr. 23, 2015. Each of the above applications is hereby expressly incorporated by reference, in their entirety, into the present application.

### BACKGROUND OF THE INVENTION

### 1. Field of the Invention

The present invention relates to an image processing device, an imaging device, an image processing method, and a program, and particularly, to an image processing device, an imaging device, an image processing method, and a program which perform image processing on an image of a visible light image and an image of a near-infrared ray image based on a point spread function.

### 2. Description of the Related Art

A point spread phenomenon in which a point subject is slightly spread may be seen in a subject image imaged through an optical system due to an influence such as diffraction and aberration caused by the optical system. A function representing a response to a point light source of the optical system is called a point spread function (PSF), and is known as characteristics that determine resolution deterioration (blurring) of an imaged image.

A point image restoration process is performed on the imaged image of which the image quality is deteriorated due to the point spread phenomenon based on the PSF, and thus, it is possible to recover the image quality thereof The point image restoration process is a process of previously acquiring deterioration characteristics (point image characteristics) caused by an aberration of a lens (optical system) and canceling or reducing the point spread of the imaged image through image processing using a restoration filter (recovery filter) corresponding to the point image characteristics.

The point image restoration process may be greatly divided into an amplitude restoration process and a phase correction process. The amplitude restoration process is a process of equalizing, that is, recovering modulation transfer function (MTF) characteristics deteriorated by the optical system, and the phase correction process is a process of equalizing, that is, recovering phase transfer function (PTF) characteristics deteriorated by the optical system.

Intuitively, the phase correction process is a process of moving an image depending on a frequency such that a point-asymmetric PSF shape is returned to a point-symmetric shape if possible.

The amplitude restoration process and the phase correction process may be simultaneously applied as signal processing, but it is possible to perform only one of these processes by correcting a method of designing a filter coefficient.

For example, WO2014/148074A discloses a technology that performs a point image restoration process of performing an amplitude restoration process and a phase correction process and a point image restoration process of performing an amplitude restoration process without phase correction.

For example, JP2008-113704A discloses a technology that performs a point image restoration process (convolution arithmetic) on an image acquired by irradiating a subject with visible light or a near-infrared ray by changing arithmetic coefficients in the visible light and the near-infrared ray.

There is a surveillance camera as a camera that is provided in a fixed point and performs imaging regardless of the day or night. In the camera such as the surveillance camera, it is necessary to acquire appropriate images in an imaging condition of the daytime and an imaging condition of the nighttime. For example, in a case where the surveillance camera images the visible light image of the subject in the daytime and images the near-infrared ray image of the subject in the nighttime, the surveillance camera needs to perform appropriate image processing depending on the imaging condition of the daytime and the imaging condition of the nighttime.

### SUMMARY OF THE INVENTION

Both the amplitude restoration process and the phase correction process of the point image restoration process are performed on image data of a blurred image, and thus, the blurring is properly corrected. For example, both the amplitude restoration process and the phase correction process of the point image restoration process are performed on an image acquired by imaging the visible light image of the subject, and thus, the blurring is clearly corrected.

In a case where an intense point image restoration process of performing both the amplitude restoration process and the phase correction process is performed on an image acquired under an environment in which light amount is small or an image having a high noise ratio in the image, the point image restoration process fails, and an unnatural image may be acquired. In this case, the image acquired by imaging the near-infrared ray image of the subject has a light amount smaller than that of the image acquired by imaging the visible light image of the subject, a noise ratio is high, and a blurry image may be acquired. Thus, for example, in a case where the intense point image restoration process of performing both the amplitude restoration and the phase correction on the image data of the image acquired by imaging the near-infrared ray image, there is a concern that the point image restoration process will not be performed normally and an unnatural image will be acquired.

Accordingly, it is necessary to switch the content of the point image restoration process depending on the kind (the image of the visible light image or the image of the near-infrared ray image) of the acquired (or input) image.

However, in the technology described in WO2014/148074A, the point image restoration process of performing the amplitude restoration process and the phase correction process and the amplitude restoration process without the phase correction are not switched depending on the kind (the visible light image or the near-infrared ray image) of the subject image of the acquired image.

In the technology described in JP2008-113704A, the point image restoration process is merely performed by changing the arithmetic coefficient on the visible light image and the near-infrared ray image, and the content (amplitude restoration or the phase correction) of the point image restoration process performed on the visible light image and the near-infrared ray image is not switched.

The present invention has been made in view of such circumstances, and it is an object of the present invention to provide an image processing device, an imaging device, an image processing method, and a program capable of effectively performing a point image restoration process on a visible light image and a near-infrared ray image and improving accuracy of the point image restoration process.

An image processing device which is an aspect of the present invention comprises: an image input unit that receives first image data indicating a visible light image imaged with sensitivity to a visible light wavelength band by using an optical system, and second image data indicating a near-infrared ray image imaged with sensitivity to a near-infrared ray wavelength band by using the optical system; a first restoration processing unit that performs a first restoration process using first restoration filters for performing phase correction and amplitude restoration on the received first image data, the first restoration filters being based on a point spread function for visible light of the optical system; and a second restoration processing unit that performs a second restoration process using second restoration filters for performing amplitude restoration without phase correction on the received second image data, the second restoration filters being based on a point spread function for a near-infrared ray of the optical system.

According to the present aspect, the first restoration process of performing the phase correction and the amplitude restoration is performed on the first image data which is the visible light image, and the second restoration process of performing the amplitude restoration without the phase correction is performed on the second image data which is the near-infrared ray image. Accordingly, in the present aspect, it is possible to effectively perform a point image restoration process on the visible light image and the near-infrared ray image and improving accuracy of the point image restoration process. That is, in the present aspect, it is possible to properly correct blurring caused in the first image data which is the visible light image, and it is possible to accurately perform the point image restoration process on the second image data which is the near-infrared ray image.

An image processing device which is another aspect of the present invention comprises: an image input unit that receives first image data imaged by using an optical system in which an infrared cut filter is inserted into an imaging optical path, and second image data imaged by using the optical system in which the infrared cut filter retreats from the imaging optical path; a first restoration processing unit that performs a first restoration process using first restoration filters for performing phase correction and amplitude restoration on the received first image data, the first restoration filters being based on a point spread function of the optical system; and a second restoration processing unit that performs a second restoration process using second restoration filters for performing amplitude restoration without phase correction on the received second image data, the second restoration filters being based on a point spread function of the optical system.

According to the present aspect, the first restoration process of performing the phase correction and the amplitude restoration is performed on the first image data imaged by using the optical system in which the infrared cut filter is inserted into the imaging optical path, and the second restoration process of performing the amplitude restoration without the phase correction is performed on the second image data imaged by using the optical system in which the infrared cut filter retreats from the imaging optical path. Accordingly, in the present aspect, it is possible to effectively perform a point image restoration process on the visible light image and the near-infrared ray image and improving accuracy of the point image restoration process. That is, in the present aspect, it is possible to properly correct blurring caused in the first image data which is the visible light image, and it is possible to accurately perform the point image restoration process on the second image data which is the near-infrared ray image.

Preferably, the first image data is image data having a plurality of colors that includes a first color which contributes to acquisition of luminance data the most and two or more second colors other than the first color, and the first restoration processing unit performs the first restoration process using the first restoration filters corresponding to the colors of the plurality of colors on the image data having the plurality of colors.

According to the present aspect, the first restoration process using the first restoration filters corresponding to the respective colors constituting the first image data is performed on the plurality of colors that includes the first color which contributes to the acquisition of the luminance data the most and the two or more second colors other than the first color. Accordingly, in the present aspect, it is possible to effectively suppress a lateral chromatic aberration caused in the visible light image. In the present aspect, it is possible to reduce an image processing calculation load by omitting the phase correction performed on the near-infrared ray image in which the lateral chromatic aberration is not theoretically caused since the near-infrared ray image is an image of monochromatic light such as the near-infrared ray.

Preferably, the image processing device further comprises: a tone correction processing unit that performs non-linear tone correction on the first image data. The tone correction processing unit performs the non-linear tone correction on the first image data on which the phase correction is performed, and the first restoration processing unit performs the amplitude restoration on the first image data on which the non-linear tone correction is performed.

According to the present aspect, the non-linear tone correction is performed on the first image data on which the phase correction is performed, and the amplitude restoration is performed on the first image data on which the non-linear tone correction is performed. Accordingly, in the present aspect, since the phase correction is performed before the tone correction (before the frequency characteristics of the image are changed), it is possible to effectively perform the phase correction. Further, since the amplitude restoration is performed after the tone correction, it is possible to prevent an artifact from being greatly caused without amplifying (emphasizing) overshoot or undershoot slightly caused due to the amplitude restoration through the tone correction.

Preferably, the image processing device further comprises: a tone correction processing unit that performs non-linear tone correction on the first image data. The tone correction processing unit performs the non-linear tone correction on the first image data on which the amplitude restoration is performed, and the first restoration processing unit performs the phase correction on the first image data on which the non-linear tone correction is performed.

In the present aspect, of the amplitude restoration and the phase correction, the amplitude restoration is performed before the tone correction, and the phase correction is performed after the tone correction. Accordingly, in the present aspect, the phase correction filter greatly spreads spatially, and thus, a phenomenon in which an artifact (ringing) is caused around a saturated pixel easily occurs in the phase correction process. However, it is possible to prevent the artifact from being amplified due to the tone correction (the artifact from being greatly caused) by performing the phase correction after the tone correction. Similarly, in the present aspect, a phenomenon in which color gradation is changed due to the phase correction may occur but it is possible to alleviate the phenomenon. Accurately, the phenomenon in which the color gradation is changed also occurs due to the phase correction after the tone correction, but it is possible to further reduce the number of times of the phenomenon occurrence than in a case where the phase correction is performed before the tone correction. In the present aspect, since the number of bits of the image data acquired after the tone correction is less than that of the image data acquired before the tone correction, it is possible to reduce the calculation load in a case where the phase correction using the phase correction filter of which the number of taps is relatively great is performed.

Preferably, the image processing device further comprises: at least one of a common restoration process arithmetic unit that is used in a restoration process arithmetic of the first restoration processing unit and the second restoration processing unit, a common tone correction arithmetic unit that performs non-linear tone correction on the first image data and the second image data, or a common contour emphasis processing unit that performs a contour emphasis process on the first image data and the second image data.

According to the present aspect, at least one of the restoration process arithmetic, the tone correction arithmetic, or the contour emphasis correction is common to the image processing on the first image data and the image processing on the second image data. Accordingly, in the present aspect, since a part of an image processing circuit is commonly used, it is possible to simplify the design of the image processing circuit.

Preferably, the image processing device further comprises: a storage unit that stores the first restoration filters and the second restoration filters.

According to the present aspect, since the first restoration filters and the second restoration filters are stored in the storage unit and the restoration filters stored in the storage unit are used by the first restoration processing unit and the second restoration processing unit, it is possible to reduce the calculation load for generating the restoration filters.

Preferably, the image processing device further comprises: a filter generation unit that generates the first restoration filters and the second restoration filters.

According to the present aspect, since the first restoration filters and the second restoration filters are generated by the filter generation unit and the restoration filters generated in the generation unit are used by the first restoration processing unit and the second restoration processing unit, it is possible to reduce a storage capacity for storing the restoration filters.

An imaging device which is still another aspect of the present invention comprises: an optical system; a cut filter operation mechanism that inserts or retreats an infrared cut filter into or from an imaging optical path of the optical system; an image acquisition unit that acquires first image data imaged by using the optical system in which the infrared cut filter is inserted into the imaging optical path and second image data imaged by using the optical system in which the infrared cut filter retreats from the imaging optical path; a first restoration processing unit that performs a first restoration process using first restoration filters for performing phase correction and amplitude restoration on the acquired first image data, the first restoration filters being based on a point spread function of the optical system; and a second restoration processing unit that performs a second restoration process using second restoration filters for performing amplitude restoration without phase correction on the acquired second image data, the second restoration filters being based on a point spread function of the optical system.

According to the present aspect, the first restoration process of performing the phase correction and the amplitude restoration is performed on the first image data imaged by using the optical system in which the infrared cut filter is inserted into the imaging optical path, and the second restoration process of performing the amplitude restoration without the phase correction is performed on the second image data imaged by using the optical system in which the infrared cut filter retreats from the imaging optical path. Accordingly, in the present aspect, it is possible to effectively perform a point image restoration process on the visible light image and the near-infrared ray image and improving accuracy of the point image restoration process. That is, in the present aspect, it is possible to properly correct blurring caused in the first image data which is the visible light image, and it is possible to accurately perform the point image restoration process on the second image data which is the near-infrared ray image.

Preferably, in the imaging device, an image surface position is set by using a case where the image acquisition unit acquires the first image data as a criterion.

According to the present aspect, the position of the image surface of the image acquisition unit is set by using a case where the first image data is acquired as its criterion. That is, in the present aspect, the position of the image surface of the image acquisition unit is set by using a case where a subject is imaged with visible light. Accordingly, in the present aspect, in a case where the infrared cut filter retreats from the imaging optical path and the imaging is performed, blurring of a subject image of the near-infrared ray is suppressed due to a wavelength difference between the visible light and the near-infrared ray even though an optical path adjustment tool such as transparent glass as a dummy filter is inserted into the imaging optical path. In the present aspect, since the image surface position of the image acquisition unit (imaging element) is set by using a case where the visible light image is imaged as its criterion, the image forming surface of the near-infrared ray image is shifted from the set image surface position of the image acquisition unit (imaging element). Thus, the phase of the PSF disappears, and thus, there is a low necessity for the phase correction.

An image processing method which is still another aspect of the present invention comprises: an image input step of receiving first image data imaged by using an optical system in which an infrared cut filter is inserted into an imaging optical path and second image data imaged by using the optical system in which the infrared cut filter retreats from the imaging optical path; a first restoration processing step of performing a first restoration process using first restoration filters for performing phase correction and amplitude restoration on the received first image data, the first restoration filters being based on a point spread function of the optical system; and a second restoration processing step of performing a second restoration process using second restoration filters for performing amplitude restoration without phase correction on the input second image data, the second restoration filters being based on a point spread function of the optical system.

A program which is still another aspect of the present invention causes a computer to perform: an image input step of receiving first image data imaged by using an optical system in which an infrared cut filter is inserted into an imaging optical path and second image data imaged by using the optical system in which the infrared cut filter retreats from the imaging optical path; a first restoration processing step of performing a first restoration process using first restoration filters for performing phase correction and amplitude restoration on the received first image data, the first restoration filters being based on a point spread function of the optical system; and a second restoration processing step of performing a second restoration process using second restoration filters for performing amplitude restoration without phase correction on the input second image data, the second restoration filters being based on a point spread function of the optical system. The aspect of the present invention includes a non-transitory computer-readable tangible medium having the program recorded thereon.

According to the present invention, since the first restoration process of performing the phase correction and the amplitude restoration is performed on the first image data which is the visible light image and the second restoration process of performing the amplitude restoration without the phase correction is performed on the second image data which is the near-infrared ray image, it is possible to effectively perform a point image restoration process on the visible light image and the near-infrared ray image and improve accuracy of the point image restoration process.

### BRIEF DESCRIPTION OF THE DRAWINGS

FIG. 1 is a block diagram showing a functional configuration example of a digital camera.

FIG. 2 is a diagram for describing a case where imaging is performed by the digital camera shown in FIG. 1 in the nighttime.

FIG. 3 is a block diagram showing a functional configuration example of a camera main body controller.

FIG. 4 is a diagram showing an outline of a first restoration process.

FIG. 5 is a diagram showing an outline of a second restoration process.

FIG. 6 is a block diagram showing a functional configuration example of an image processing unit.

FIG. 7 is a block diagram showing a functional configuration example of a first restoration processing unit.

FIG. 8 is a block diagram showing a functional configuration example of a second restoration processing unit.

FIG. 9 is a flowchart showing an operation of the image processing device.

FIGS. 10A and 10B are diagrams for describing a focus and a positional relationship between an image forming surface and an image surface of an imaging element.

FIGS. 11A and 11B are diagrams for describing the focus and the positional relationship between the image forming surface and the image surface of the imaging element.

FIGS. 12A and 12B are diagrams for describing the focus and the positional relationship between the image forming surface and the image surface of the imaging element.

FIGS. 13A and 13B are diagrams for describing the focus and the positional relationship between the image forming surface and the image surface of the imaging element.

FIG. 14 is a diagram showing an outline of a first restoration process according to a second embodiment.

FIG. 15 is a block diagram showing a functional configuration example of an image processing unit according to the second embodiment.

FIG. 16 is a graph showing an example of input and output characteristics (gamma characteristics) that a tone is corrected by a tone correction processing unit.

FIG. 17 is a block diagram showing an example of a specific process of the image processing unit according to the second embodiment.

FIG. 18 is a block diagram showing an example of a specific process of the image processing unit according to the second embodiment.

FIG. 19 is a block diagram showing a functional configuration example of a phase correction processing unit.

FIG. 20 is a block diagram showing an example of a specific process of the image processing unit according to the second embodiment.

FIG. 21 is a block diagram showing a functional configuration example of an amplitude restoration processing unit.

FIG. 22 is a block diagram showing an example of a specific process of the image processing unit according to the second embodiment.

FIG. 23 is a block diagram showing an example of a specific process of the image processing unit according to the second embodiment.

FIG. 24 is a block diagram showing a functional configuration example of the amplitude restoration processing unit.

FIG. 25 is a block diagram showing an example of a specific process of an image processing unit according to a third embodiment.

FIG. 26 is a block diagram showing one embodiment of an imaging module including an EDoF optical system.

FIG. 27 is a diagram showing an example of the EDoF optical system.

FIG. 28 is a diagram showing a restoration example of an image acquired through the EDoF optical system.

### DESCRIPTION OF THE PREFERRED EMBODIMENTS

Embodiments of the present invention will be described with reference to the accompanying drawings. In the following embodiments, a digital camera (imaging device) to be used as an example of a surveillance camera capable of being connected to a computer (personal computer) will be described.

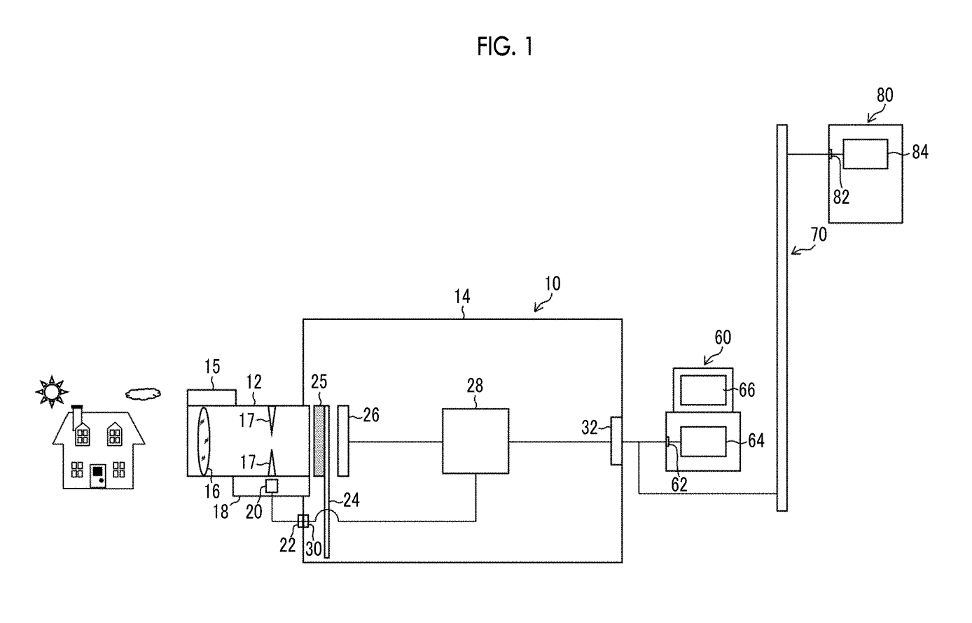

FIG. 1 is a block diagram showing a functional configuration example of a digital camera 10 connected to a computer. The digital camera 10 is capable of imaging a video or a still image, and an image or image data in the following description means an image or a still image of one frame in the video. FIG. 1 shows a case where the imaging is performed by the digital camera 10 in the daytime.

The digital camera 10 includes a lens unit 12 and a camera main body 14 including an imaging element (image acquisition unit) 26, and the lens unit 12 and the camera main body 14 are electrically connected through a lens-unit input and output unit 22 of the lens unit 12 and a camera-main-body input and output unit 30 of the camera main body 14.

The lens unit 12 includes an optical system such as a lens 16 or a stop 17, and an optical system operation unit 18 that controls the optical system. The optical system operation unit 18 includes a manual operation unit that adjusts a focus position of the lens 16 and a stop driving unit that drives the stop 17 by using a control signal to be applied from a camera main body controller 28.

The lens unit 12 includes a near-infrared ray emitting unit 15. The near-infrared ray emitting unit 15 emits a near-infrared ray as auxiliary light in a case where an image of a near-infrared ray image is acquired by the digital camera 10. That is, in a case where the digital camera 10 performs imaging in the nighttime, since the near-infrared ray is emitted as the auxiliary light from the near-infrared ray emitting unit 15, the digital camera 10 may acquire a clear near-infrared ray image.

The near-infrared ray image is an image including a near-infrared ray image of a imaged subject, and is represented by second image data. The near-infrared ray image is acquired by being imaged with sensitivity to a near-infrared ray wavelength band, or is acquired by being imaged by using an optical system in which an IR cut filter 25 retreats from an imaging optical path. In this example, a wavelength of the near-infrared ray is not particularly limited, and ranges, for example, from 0.7 μm to 2.5 μm. A visible light image is an image including a visible light image of an imaged subject, and is represented by first image data. The visible light image is acquired by being imaged with sensitivity to a visible light wavelength band, or is acquired by being imaged by using an optical system in which the IR cut filter 25 is inserted into the imaging optical path.

The infrared (IR) cut filter (infrared ray cut filter) 25 is provided in a cut filter operation mechanism 24. In a case where the imaging is performed in the daytime by using the digital camera 10, the IR cut filter 25 is inserted into the imaging optical path as shown in FIG. 1. The IR cut filter 25 is inserted into the imaging optical path, and thus, the IR cut filter 25 shields an infrared ray. Thus, the infrared ray does not reach the imaging element 26. Various filters may be used as the IR cut filter 25, and is used, for example, as a near-infrared cut filter capable of shielding the near-infrared ray.

The imaging element (image acquisition unit) 26 of the camera main body 14 is a complementary metal-oxide semiconductor (CMOS) type color image sensor. The imaging element 26 is not limited to the CMOS type, and may be an XY address type or charge-coupled device (CCD) type image sensor.

The imaging element 26 includes a plurality of pixels arranged in a matrix shape, and each pixel includes a microlens, a color filter of red (R), green (G), or blue (B), and a photoelectric conversion unit (photodiode). The RGB color filters have a filter array (Bayer array or X-Trans (registered trademark) array) of a predetermined pattern.

The imaging element 26 of the present example outputs original image data by imaging a subject image using the optical system, and the original image data is transmitted to an image processing unit 35 of the camera main body controller 28.

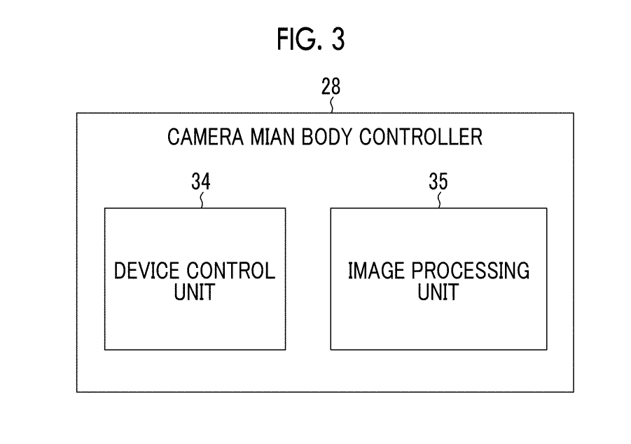

The camera main body controller 28 includes a device control unit 34 and the image processing unit (image processing device) 35 as shown in FIG. 3, and generally controls the camera main body 14 For example, the device control unit 34 controls an output of an image signal (image data) from the imaging element 26, generates a control signal for controlling the lens unit 12, transmits the generated control signal to the lens unit 12 (lens unit controller 20) through the camera-main-body input and output unit 30, and transmits image data items (RAW data or JPEG data) acquired before and after the image processing to an external device (computer 60) connected through an input and output interface 32. The device control unit 34 appropriately controls various devices included in the digital camera 10.

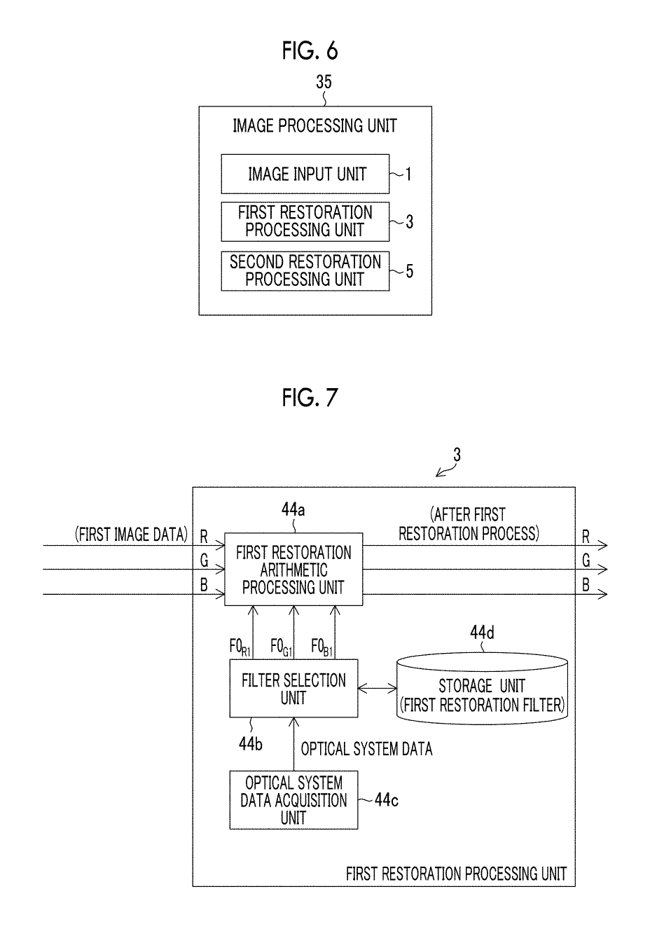

The image processing unit 35 may perform arbitrary image processing on the image signal from the imaging element 26 when necessary. Particularly, the image processing unit 35 of the present example includes a first restoration processing unit 3 (FIG. 6) that performs a point image restoration process on the first image data based on a point spread function of the optical system and a second restoration processing unit 5 (FIG. 6) that performs the point image restoration process on the second image data based on the point spread function of the optical system. The details of the image processing unit 35 will be described below.

The image data on which the image processing is performed in the camera main body controller 28 is sent to the computer 60 through the input and output interface 32. A format of the image data sent to the computer 60 from the digital camera 10 (camera main body controller 28) is not particularly limited, and an arbitrary format such as RAW, the Joint Photographic Experts Group (JPEG), or Tagged Image File Format (TIFF) may be used. Accordingly, the camera main body controller 28 may correlate a plurality of associated data items such as header information (imaging information (an imaging date and time, a device type, the number of pixels, a stop value, or the presence or absence of the IR cut filter 25)), main image data, and thumbnail image data with each other, may generate the correlated data items as one image file like Exchangeable image file format (Exif), and may transmit the generated image file to the computer 60.

The computer 60 is connected to the digital camera 10 through the input and output interface 32 of the camera main body 14 and a computer input and output unit 62, and receives data items such as image data sent from the camera main body 14. A computer controller 64 generally controls the computer 60, performs image processing on the image data from the digital camera 10, and controls communication with a server 80 connected to the computer input and output unit 62 through a network line such as the Internet 70. The computer 60 includes a display 66, and displays the image transmitted from the digital camera 10. The processing contents of the computer controller 64 are displayed on the display 66 when necessary. A user may input data or commands to the computer controller 64 by operating input means (not shown) such as a keyboard while checking display data on the display 66. Accordingly, the user may control the computer 60 or devices (digital camera 10 or the server 80) connected to the computer 60.

The server 80 includes a server input and output unit 82 and a server controller 84. The server input and output unit 82 constitutes a transmission and reception connection unit with respect to external devices such as the computer 60, and is connected to the computer input and output unit 62 of the computer 60 through the network line such as the Internet 70. In response to a control instruction signal from the computer 60, the server controller 84 cooperates with the computer controller 64, performs the transmission and reception of data items with the computer controller 64, and downloads the data items to the computer 60. Further, the server controller performs an arithmetic process on the data items, and transmits the arithmetic result to the computer 60.

The controllers (the lens unit controller 20, the camera main body controller 28, the computer controller 64, and the server controller 84) each have circuits required in a control process, and each include, for example, an arithmetic processing circuit (central processing unit (CPU)), or a memory. Communication between the digital camera 10, the computer 60, and the server 80 may be performed in a wired or a wireless manner. The computer 60 and the server 80 may be integrally provided, or the computer 60 and/or the server 80 may not be provided. The digital camera 10 may directly perform the transmission and reception of data items between the digital camera 10 and the server 80 by having a function of communicating with the server 80.

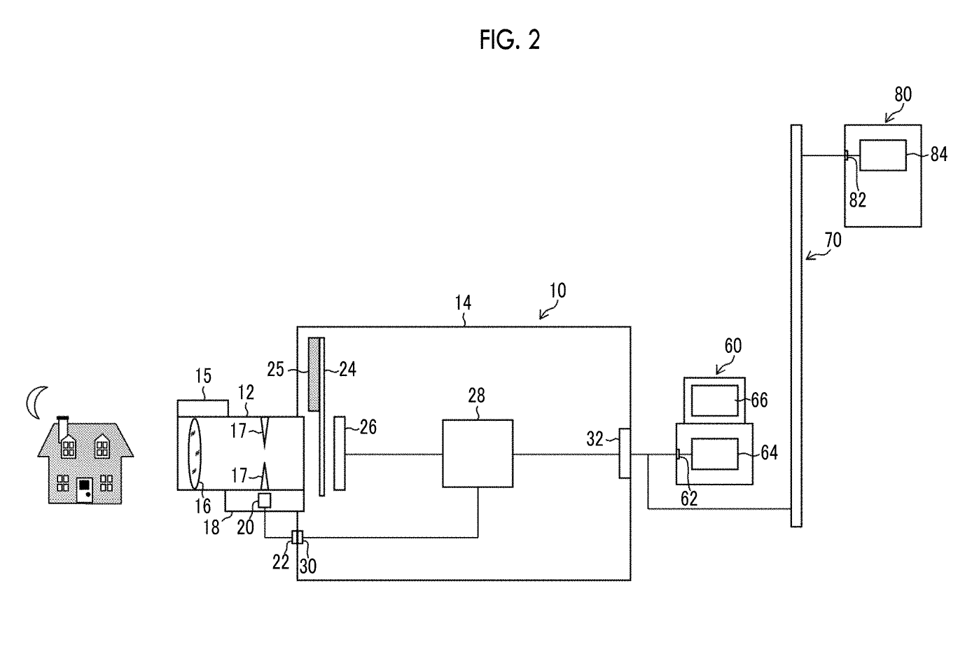

FIG. 2 is a block diagram showing a case where the imaging is performed by the digital camera 10 shown in FIG. 1 in the nighttime. The components described in FIG. 1 will be assigned the same reference numerals, and the description will be omitted.

As shown in FIG. 2, in a case where the imaging is performed by the digital camera 10 in the nighttime, the IR cut filter 25 retreats from the imaging optical path by the cut filter operation mechanism 24. As mentioned above, in a case where the IR cut filter 25 retreats from the imaging optical path of the optical system, the near-infrared ray cut by the IR cut filter 25 is incident on the imaging element 26. Accordingly, it is possible to acquire an infrared ray image including an infrared ray image of the subject in the case shown in FIG. 2. Since the imaging is performed in the nighttime, the near-infrared ray emitting unit 15 emits the near-infrared ray as the auxiliary light.

Hereinafter, the point image restoration process performed on imaged data (first image data) of the visible light image of the subject acquired through the imaging element 26 and imaged data (second image data) of the near-infrared ray image of the subject will be described.

Although it will be described in the following examples that the point image restoration process is performed in the camera main body 14 (camera main body controller 28), the entire point image restoration process or a part thereof may be performed in other controllers (the lens unit controller 20, the computer controller 64, and the server controller 84).

The point image restoration process of the present example includes a first restoration process using first restoration filters for performing phase correction and amplitude restoration and a second restoration process using second restoration filters for performing amplitude restoration without the phase correction.

### First Embodiment

Initially, the first restoration process will be described.

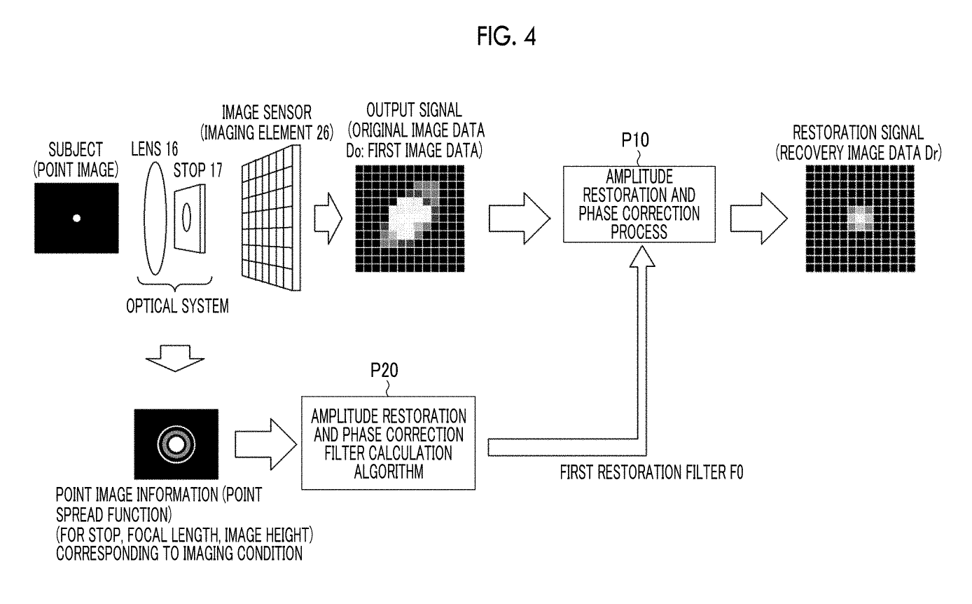

FIG. 4 is a diagram showing the outline of the first restoration process in a case where the first image data is acquired as original image data Do.

As shown in FIG. 4, in a case where a point image is imaged as a subject, the visible light image of the subject is received by the imaging element 26 (image sensor) through the optical system (the lens 16 and the stop 17), and the first image data is output from the imaging element 26. An amplitude component and a phase component of the first image data deteriorate due to a point spread phenomenon caused by characteristics of the optical system, and the original subject image (point image) is a point-asymmetric blurred image. In this example, since the visible light includes light rays (various color light rays) having various wavelength bands, a lateral chromatic aberration occurs, and PTF characteristics of the first image data deteriorate (phase is shifted).

The point image restoration process is a process of restoring a high-resolution image by acquiring characteristics of deterioration (the point spread function (PSF) or the optical transfer function (OTF)) due to an aberration of the optical system and performing the restoration process on the imaged image (deteriorated image) by using restoration (recovery) filters generated based on the PSF or the OTF.

The PSF and the OTF have a relationship of Fourier transform. The PSF is a real function, and the OTF is a complex function. As functions having equivalent information to these functions, there are a modulation transfer function or an amplitude transfer function (MTF) and the phase transfer function (PTF). These functions indicate the amplitude component and the phase component of the OTF, respectively. The amount of information items of the MTF and the PTF is equivalent to that of the OTF or the PSF.

In general, a convolution type Wiener filter may be used in restoring the blurred image using the PSF. Frequency characteristics d(ωₓ, ω_{y}) of the restoration filter may be calculated by the following expression by referring to information of a signal-noise ratio (SNR) and the OTF acquired by performing Fourier transform on PSF(x, y).

$$d ( {ω}_{x} , {ω}_{y} ) = \frac{{H}^{*} ( {ω}_{x} , {ω}_{y} )}{{‖ {H}^{*} ( {ω}_{x} , {ω}_{y} ) ‖}^{2} + 1 / SNR ( {ω}_{x} , {ω}_{y} )} \qquad [ Expression 1 ]$$

Where, H(ωₓ, ω_{y}) represents the OTF, and H*(ωₓ, ω_{y}) represents the complex conjugate. SNR(ωₓ, ω_{y}) represents a signal-noise (SN) ratio.

Designing filter coefficients of the restoration filter is an optimization problem of selecting coefficient values such that the frequency characteristics of the filter are closest to the desired Wiener frequency characteristics, and the filter coefficients are appropriately calculated by a known arbitrary method.

As shown in FIG. 4, in order to restore the original subject image (point image) from the original image data Do (first image data) the blurred image, an amplitude restoration and phase correction process (first restoration process) P10 using filters (first restoration filters F0) for performing amplitude restoration and phase correction is performed on the original image data Do. Thus, the amplitude of the point-asymmetric blurred image is restored, and the blurred image becomes small. Further, the point-asymmetric image moves depending on the frequency, and is recovered to a point-symmetric image. Accordingly, recovery image data Dr indicating an image (recovery image) closer to the original subject image (point image) is acquired.

The first restoration filters F0 used in the amplitude restoration and phase correction process (first restoration process) P10 are acquired by a predetermined amplitude restoration and phase correction filter calculation algorithm P20 from point image information (PSF and OTF) of the optical system corresponding to an imaging condition in a case where the original image data Do is acquired.

The point image information of the optical system may be changed depending on various imaging conditions such as a stop amount, a focal length, a zoom amount, an image height, the number of record pixels, and a pixel pitch in addition to the type of the lens 16. The point image information of the optical system may also be changed depending on the visible light and the near-infrared ray. Accordingly, in a case where the first restoration filters F0 are calculated, these imaging conditions are acquired.

The first restoration filters F0 are filters in a real space constituted, for example, by N×M (N and M are integers of 2 or more) taps, and are applied to image data as a processing target. Accordingly, a weighted averaging arithmetic (deconvolution arithmetic) is performed on the filter coefficients assigned to the taps and the corresponding pixel data items (processing target pixel data items and adjacent pixel data items of the image data), and thus, pixel data items acquired after the point image restoration process may be calculated. A weighted averaging process using the first restoration filters F0 is applied to all the pixel data items constituting the image data while sequentially changing the target pixels, and thus, the point image restoration process may be performed.

Although it has been described in the example shown in FIG. 4 that the amplitude restoration and the phase correction are performed together in the first restoration process, the present embodiment is not limited thereto. That is, the amplitude restoration process and the phase correction process may be performed as individual processes by calculating filters capable of performing the amplitude restoration and calculating filters capable of performing the phase correction in the first restoration process.

Hereinafter, the second restoration process will be described.

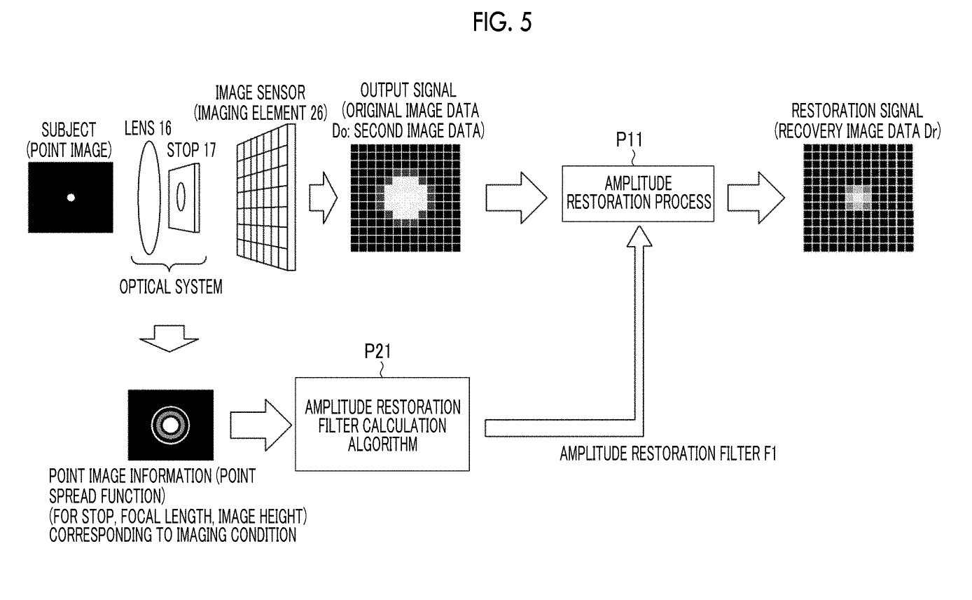

FIG. 5 is a diagram showing the outline of the second restoration process in a case where the second image data is acquired as the original image data Do.

As shown in FIG. 5, in a case where the point image is imaged as the subject, the near-infrared ray image of the subject is received by the imaging element 26 (image sensor) through the optical system (lens 16 and the stop 17), and the second image data is output from the imaging element 26. For example, the amplitude component of the second image data deteriorates due to the point spread phenomenon caused by the characteristics of the optical system, and the original subject image (point image) becomes a blurred image. In this example, for example, since the near-infrared ray is monochromatic light, the lateral chromatic aberration does not occur, and the image of the monochromatic light may become the symmetric blurred image with no phase shift. Accordingly, it is not necessary to perform the phase correction on the second image data which is the symmetric blurred image, and only the amplitude restoration process is performed on the second image data. Thus, it is possible to reduce a calculation load of the image processing.

For example, in the second restoration processing unit 5, the frequency characteristics of the filter are calculated by using the MTF indicating the amplitude component of the OTF and the coefficient values are selected such that the calculated frequency characteristics of the filter are closest to the desired Wiener frequency characteristics. Thus, amplitude restoration filters F1 for recovering deterioration in the frequency characteristics are calculated (P21). In this case, the amplitude restoration filters F1 serve as the second restoration filters.

As shown in FIG. 5, in order to restore the original subject image (point image) from the original image data Do of the blurred image, an amplitude restoration process P11 using the amplitude restoration filters F1 is performed on the original image data Do. Thus, the amplitude of the point-asymmetric blurred image is restored, and the blurred image becomes small. The point image restoration process of performing the amplitude restoration without the phase correction is performed on the second image data, and thus, it is possible to improve accuracy of the point image restoration process.

Hereinafter, the image processing device (image processing unit) 35 will be described.

FIG. 6 is a block diagram showing a functional configuration example of the image processing unit 35.

The image processing unit 35 includes an image input unit 1, a first restoration processing unit 3, and a second restoration processing unit 5.

The first image data and the second image data are input to the image input unit 1. The method of inputting the data items to the image input unit 1 is not particularly limited. For example, the first image data and the second image data may be simultaneously input to the image input unit 1, or the first image data and the second image data may be input in different timings. In a case where the first image data is input, the image input unit 1 sends the input first image data to the first restoration processing unit 3. In a case where the second image data is input, the image input unit 1 sends the input second image data to the second restoration processing unit 5. Here, for example, the camera main body controller 28 acquires information indicating whether the IR cut filter 25 is inserted into the imaging optical path or retreats from the imaging optical path by the device control unit 34, and sends the information indicating whether the IR cut filter 25 is inserted into the imaging optical path or retreats from the imaging optical path to the image input unit 1 of the image processing unit 35. The image input unit 1 determines whether the input image data is the first image data or the second image data by using the information indicating whether the IR cut filter 25 is inserted into the imaging optical path or retreats from the imaging optical path. This determination performed by the image input unit 1 is not particularly limited. For example, information indicating whether or not the kind of each image data item is the first image data or the second image data may be assigned to the each image data item, and the image input unit 1 may determine the kind of the image data based on this information.

The first restoration processing unit 3 acquires the first image data from the image input unit 1. The first restoration processing unit 3 performs the first restoration process using the first restoration filters for performing the phase correction and the amplitude restoration, and the first restoration filters are based on the point spread function for the visible light of the optical system. That is, the first restoration processing unit 3 performs the first restoration process on the first image data by using the first restoration filters generated based on the point spread function for the visible light of the optical system. The phase shift of the image on which the first restoration process is performed is corrected and the amplitude thereof is restored. Thus, an effective point image restoration process of properly correcting the blurring is performed. The phase correction is performed on the data items of RGB data items of the first image data, and thus, the lateral chromatic aberration is effectively suppressed.

The second restoration processing unit 5 acquires the second image data from the image input unit 1. The second restoration processing unit 5 performs the second restoration process using the second restoration filters performing the amplitude restoration without the phase correction, and the second restoration filters are based on the point spread function of the optical system. Since only the amplitude restoration without the phase correction is performed on the second image data, the accuracy of the point image restoration process for the second image data is good. In this example, a case where the accuracy of the point image restoration process is good means that the point image restoration process fails but a possibility that the image will become unnatural is low. Since the second restoration processing unit 5 does not perform the phase correction in which an effect is not able to be expected, it is possible to reduce the calculation load of the point image restoration process, and it is possible to acquire a clear image. In a case where an image surface position of the imaging element 26 is set by using a case where the visible light image is imaged as its criterion, since an image forming surface of the near-infrared ray image is shifted from the set image surface position of the imaging element 26, the phase of the PSF disappears, and thus, there is a low necessity for the phase correction.

As described above, the image processing unit (image processing device) 35 includes the first restoration processing unit 3 and the second restoration processing unit 5, and thus, each imaging device may not have a function of performing the point image restoration process in a case where the image processing unit 35 is provided in the computer.

FIG. 7 is a block diagram showing a functional configuration example of the first restoration processing unit 3.

The first restoration processing unit 3 includes a first restoration arithmetic processing unit 44a, a filter selection unit 44b, an optical system data acquisition unit 44c, and a storage unit 44d.

The optical system data acquisition unit 44c acquires optical system data indicating the point spread function of the optical system (lens 16 or the stop 17). The optical system data may be data which is a selection criterion of the first restoration filters in the filter selection unit 44b, and may be information which directly or indirectly indicates the point spread function of the optical system used in a case where the first image data as the processing target is imaged and acquired. Accordingly, for example, the transfer function (PSF or OTF (MTF or PTF)) related to the point spread function of the optical system may be used as the optical system data, or the type (for example, a model number of the lens unit 12 (lens 16) used in the imaging) of the optical system which indirectly indicates the transfer function related to the point spread function of the optical system may be used as the optical system data. Information items such as an F-number (stop value), a zoom value, and an image height in a case where the image is imaged may be used as the optical system data.

The storage unit 44d stores first restoration filters (F0_{R1}, F0_{G1}, and F0_{B1}) for RGB which are generated based on the transfer functions (PSF, OTF, or PTF and MTF) related to point spread functions of multiple types of optical systems. The reason why the first restoration filters (F0_{R1}, F0_{G1}, and F0_{B1}) are stored for RGB is because the aberration of the optical system is different depending on the wavelengths of the colors of the RGB (the shape of the PSF is different). Preferably, the storage unit 44d stores the first restoration filters (F0_{R1}, F0_{G1}, and F0_{B1}) corresponding to the stop value (F-number), the focal length, and the image height. This is because the shape of the PSF is different depending on these conditions. In this example, G indicates a green color, and is a first color which contributes to acquisition of luminance data the most. R indicates a red color, and is one of two or more second colors other than the first color. B indicates a blue color, and is the other one of the two or more second colors other than the first color.

The filter selection unit 44b selects the first restoration filters corresponding to the optical system data of the optical system used in a case where the first image data is imaged and acquired, among the first restoration filters stored in the storage unit 44d, based on the optical system data acquired by the optical system data acquisition unit 44c. The first restoration filters (F0_{R1}, F0_{G1}, and F0_{B1}) for RGB which are selected by the filter selection unit 44b are sent to the first restoration arithmetic processing unit 44a.

The filter selection unit 44b recognizes type information (first restoration filter storage information) of the first restoration filters stored in the storage unit 44d, and the method of recognizing the first restoration filter storage information by means of the filter selection unit 44b is not particularly limited. For example, the filter selection unit 44b may include a storage unit (not shown) that stores the first restoration filter storage information, or may also change the first restoration filter storage information stored in the storage unit of the filter selection unit 44b in a case where the type information of the first restoration filters stored in the storage unit 44d is changed. The filter selection unit 44b may be connected to the storage unit 44d, and may directly recognize the “information of the first restoration filters stored in the storage unit 44d”, or may recognize the first restoration filter storage information from another processing unit (memory) that recognizes the first restoration filter storage information.

The filter selection unit 44b may select the first restoration filters corresponding to the PSF of the optical system used in a case where the first image data is imaged and acquired, and the selection method is not particularly limited. For example, in a case where the optical system data from the optical system data acquisition unit 44c directly indicates the PSF, the filter selection unit 44b selects the first restoration filters corresponding to the PSF indicated by the optical system data. In a case where the optical system data from the optical system data acquisition unit 44c indirectly indicates the PSF, the filter selection unit 44b selects the first restoration filters corresponding to the PSF of the optical system used in a case where the first image data as the processing target is imaged and acquired, from the “optical system data indirectly indicating the PSF”.

The first image data (RGB data items) on which a demosaic process is performed is input to the first restoration arithmetic processing unit 44a. The first restoration arithmetic processing unit 44a performs the first restoration process using the first restoration filters (F0_{R1}, F0_{G1}, and F0_{B1}) selected by the filter selection unit 44b on the RGB data items, and calculates the image data after the first restoration process. That is, the first restoration arithmetic processing unit 44a performs a deconvolution arithmetic of the first restoration filters (F0_{R1}, F0_{G1}, and F0_{B1}) and the corresponding pixel data items (processing target pixels data items and adjacent pixel data items) of RGB, and calculates the RGB data items on which the first restoration process is performed.

The first restoration processing unit 3 having the above-described configuration is able to perform the phase correction process in which the phase transfer function (PTF) is reflected on for RGB color channels, and performs the effective point image restoration process of properly correcting the blurring. The first restoration processing unit 3 performs the phase correction process in which the phase transfer function (PTF) is reflected on the RGB color channels, and thus, it is possible to correct various chromatic aberrations such as the lateral chromatic aberration.

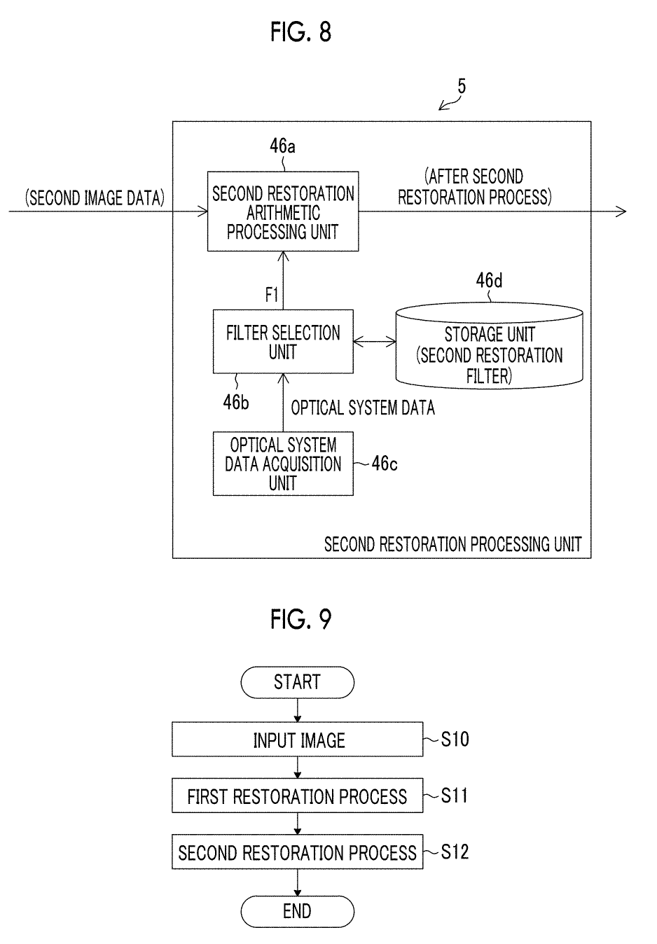

FIG. 8 is a block diagram showing a functional configuration example of the second restoration processing unit 5.

The second restoration processing unit 5 includes a second restoration arithmetic processing unit 46a, a filter selection unit 46b, an optical system data acquisition unit 46c, and a storage unit 46d.

Since the filter selection unit 46b and the optical system data acquisition unit 46c respectively correspond to the filter selection unit 44b and the optical system data acquisition unit 44c shown in FIG. 7, the detailed description thereof will be omitted.

The storage unit 46d stores the second restoration filters generated based on the PSF, OTF, or MTF of multiple types of optical systems. Preferably, the storage unit 46d stores the second restoration filters corresponding to the stop value (F-number), the focal length, and the image height. This is because the shape of the PSF is different depending on these conditions.

The filter selection unit 46b selects the second restoration filters corresponding to the optical system data of the optical system used in a case where the original image data is imaged and acquired among the second restoration filters stored in the storage unit 46d based on the optical system data acquired by the optical system data acquisition unit 46c. The second restoration filters selected by the filter selection unit 46b are sent to the second restoration arithmetic processing unit 46a.

The second restoration arithmetic processing unit 46a performs the second restoration process using the second restoration filters selected by the filter selection unit 46b on the second image data.

The storage unit 44d (FIG. 7) that stores the first restoration filters and the storage unit 46d (FIG. 8) that stores the second restoration filters may be individually provided, or these storage units may be physically the same but have different storage areas.

Although it has been described in the present example that the first restoration filters and the second restoration filters are respectively stored in the storage units 44d and 46d and the first restoration filters and the second restoration filters to be used in the point image restoration process are appropriately read, the present embodiment is not limited thereto. That is, in the present example, the transfer functions (PSF, OTF, PTF, and MTF) of the optical system may be stored in the storage unit, the transfer function to be used in the point image restoration process may be read from the storage unit in a case where the point image restoration process is performed, and a filter generation unit may be provided such that the first restoration filters and the second restoration filters are sequentially generated. Although it has been described above that the first restoration processing unit 3 (FIG. 7) and the second restoration processing unit 5 (FIG. 8) are provided as individual processing units, the present embodiment is not limited thereto. For example, the first restoration process and the second restoration process may be performed by one restoration processing unit having both functions of the first restoration processing unit 3 and the second restoration processing unit 5.

FIG. 9 is a flowchart showing an operation of the image processing unit (image processing device) 35.

Initially, the first image data and the second image data are input to the image input unit 1 of the image processing unit 35 (step S10). Thereafter, the first restoration process is performed on the first image data by the first restoration processing unit 3 (step S11). The second restoration process is performed on the second image data by the second restoration processing unit 5 (step S12).

The above-described configurations and functions may be appropriately implemented by arbitrary hardware, software, or the combination thereof. For example, the present invention may be applied to a program causing a computer to perform the above-described processing steps (processing procedure), a computer-readable recording medium (non-transitory tangible recording medium) having the program recorded thereon, or a computer in which the program is capable of being installed.

Hereinafter, settings related to the provision of the imaging element 26 of the digital camera 10 will be described.

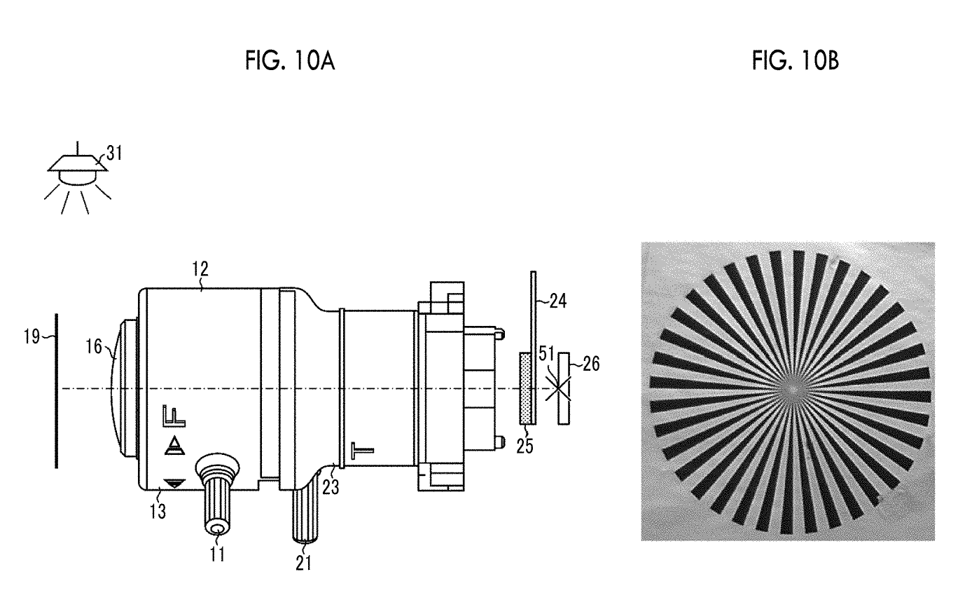

FIGS. 10A to 13B are diagrams for describing the focus and the positional relationship between the image forming surface and the image surface of the imaging element 26. The lens unit 12, the imaging element 26, the IR cut filter 25, the cut filter operation mechanism 24, and a subject 19 are mainly illustrated in FIGS. 10A, 11A, 12A, and 13A. A focus ring 13, a focus adjustment lever 11, a zoom ring 23, and a zoom adjustment lever 21 are provided on a side surface of the lens unit 12. The image surface of the imaging element 26 illustrated in FIGS. 10A, 11A, 12A, and 13A is set by using a case where the visible light image is imaged as its criterion. Images of a subject image imaged under the respective imaging conditions of FIGS. 10A to 13A are depicted in FIGS. 10B, 11B, 12B, and 13B.

A case where a fluorescent lamp 31 is turned on and the IR cut filter 25 is inserted into the imaging optical path is illustrated in FIGS. 10A and 10B. In this case, a visible light image of the subject 19 is acquired by the imaging element 26. Since the image surface position of the imaging element 26 is set by using a case where the visible light image is acquired as its criterion, an image forming surface 51 of the visible light image of the subject 19 and the image surface position of the imaging element 26 match each other (see FIG. 10A), and an image which is in focus on the subject 19 is acquired (see FIG. 10B).

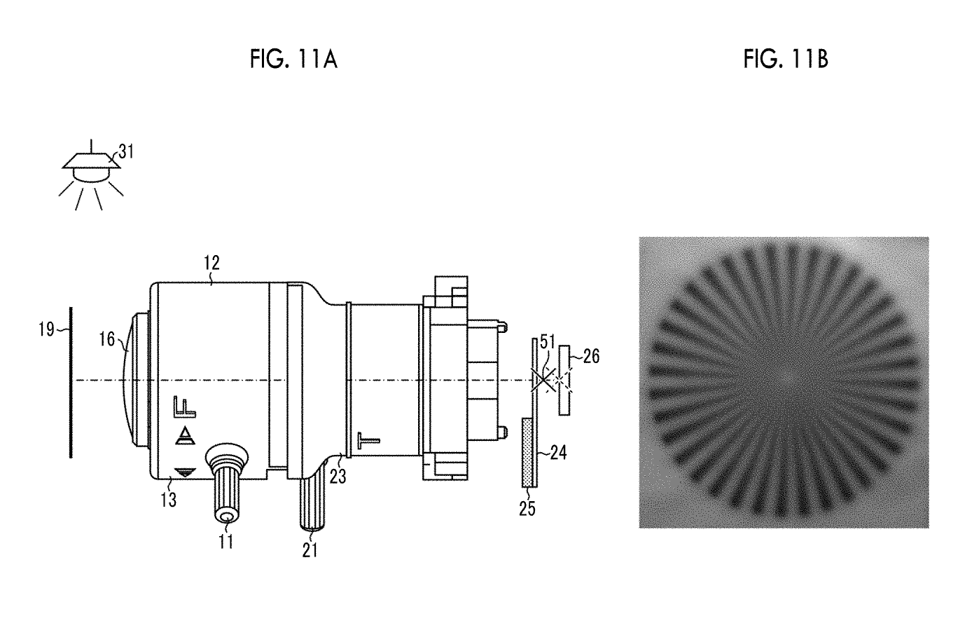

A case where the fluorescent lamp 31 is turned on and the IR cut filter 25 retreats from the imaging optical path is illustrated in FIGS. 11A and 11B. In this case, an image including the visible light image of the subject 19 is acquired by the imaging element 26. Although the image surface position of the imaging element 26 is set by using a case where the visible light image is acquired as its criterion, since the IR cut filter 25 retreats from the imaging optical path and an optical path length of the visible light image is changed, the image forming surface 51 of the visible light image of the subject 19 and the image surface position of the imaging element 26 do not match each other (see FIG. 11A). Accordingly, a blurred image which is out of focus on the subject 19 is acquired (see FIG. 11B). In this case, the IR cut filter 25 retreats from the imaging optical path and a dummy filter (transparent glass) that adjusts the optical path length is not inserted. In FIG. 11A, the image forming surface of the visible light image in a case where the IR cut filter 25 is inserted into the imaging optical path is represented by a dotted line. In a case where the IR cut filter 25 retreats from the imaging optical path, the dummy filter may be inserted into the imaging optical path. Accordingly, even in a case where the IR cut filter 25 retreats from the imaging optical path, it is possible to acquire the image which is in sharp focus on the subject.

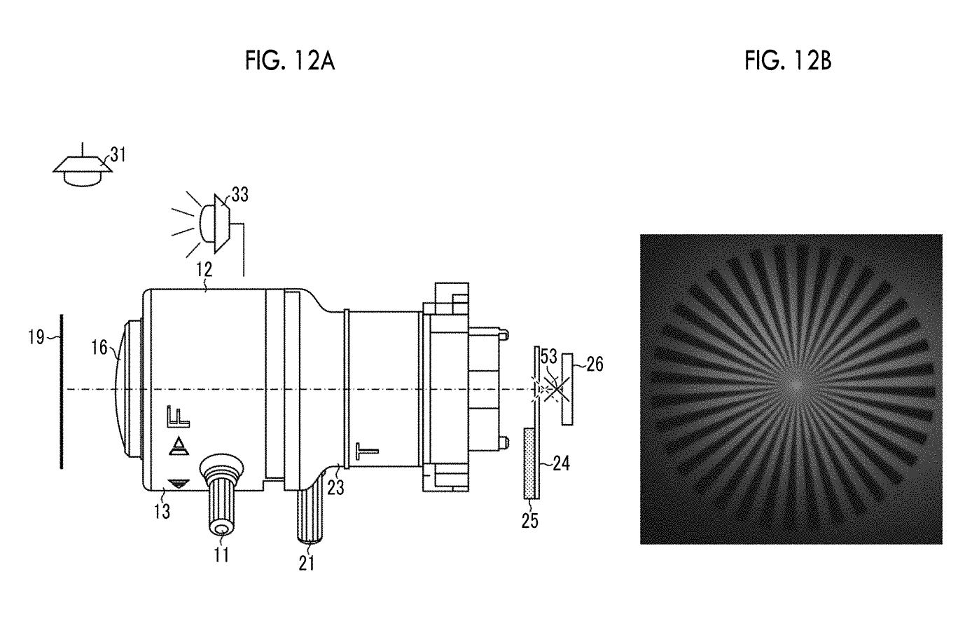

A case where the fluorescent lamp 31 is turned off, an infrared (IR) floodlight 33 that emits the near-infrared ray is turned on, and the IR cut filter 25 retreats from the imaging optical path is illustrated in FIGS. 12A and 12B. In this case, an image including a near-infrared ray image of the subject 19 is acquired by the imaging element 26. An image forming surface 53 of the near-infrared ray image of the subject 19 is closer to the imaging element 26 than the image forming surface 51 of the visible light image. Accordingly, the focus is less shifted than in the case shown in FIGS. 11A and 11B, and thus, it is possible to acquire an image in which the blurring is suppressed (see FIG. 12B). The image forming surface of the visible light image is represented by a dotted line in FIG. 12A.

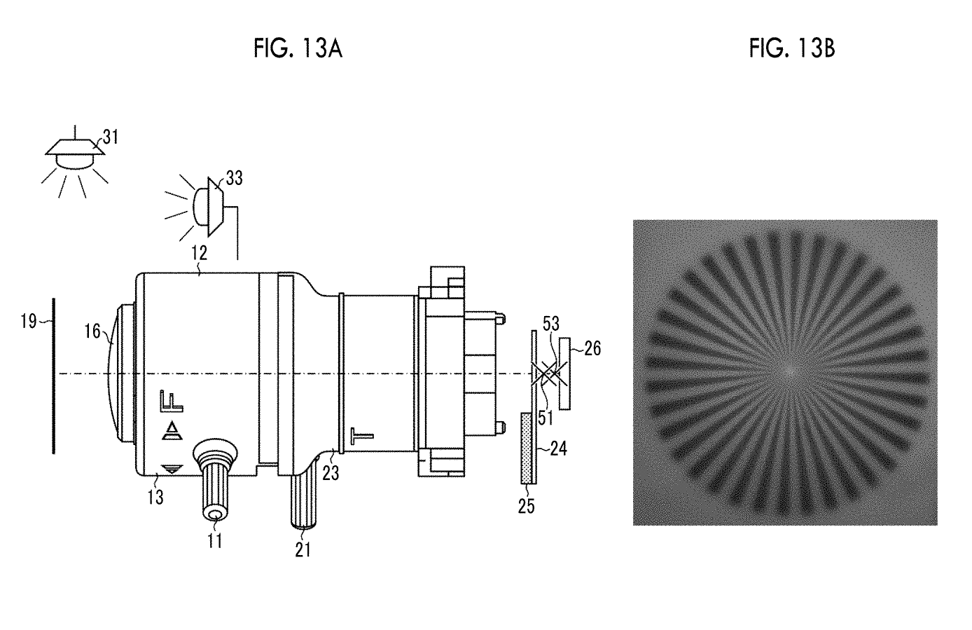

A case where the fluorescent lamp 31 is turned on, the IR floodlight 33 is turned on, and the IR cut filter 25 retreats from the imaging optical path is illustrated in FIGS. 13A and 13B. In this case, an image including the visible light image and the near-infrared ray image of the subject 19 is acquired by the imaging element 26. In this case, since the image forming surface 53 of the near-infrared ray image of the subject 19 and the image forming surface 51 of the visible light image of the subject 19 are present and a difference between the position of the image forming surface 51 of the visible light image and the image surface position of the imaging element 26 is large as described in FIGS. 11A and 11B, an image in which the blurring of the visible light image is remarkable is acquired (see FIG. 13B).

As described above, the image surface position of the imaging element 26 is set by using a case where the visible light image (first image data) of the subject 19 is acquired as its criterion, and thus, it is possible to acquire the near-infrared ray image of the subject 19 in which the blurring is suppressed even in a case where the IR cut filter 25 retreats from the imaging optical path.

### Second Embodiment

Hereinafter, a second embodiment will be described.

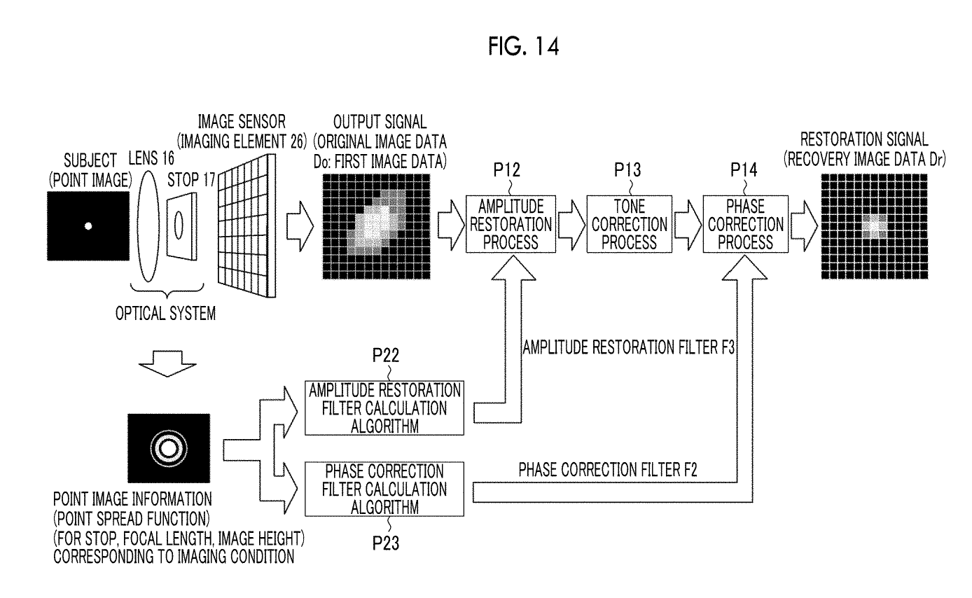

FIG. 14 is a diagram showing the outline of the first restoration process in a case where the first image data is acquired as the original image data Do according to the second embodiment. The components previously described in FIG. 4 will be assigned the same reference numerals, and the description thereof will be omitted.

In FIG. 14, the first restoration process described in FIG. 4 is separately performed as an amplitude restoration process P12 and a phase correction process P14. A non-linear tone correction process P13 is performed on the first image data on which the amplitude restoration process is performed.

In a case where the first restoration processing unit 3 separately performs the phase correction and the amplitude restoration, the frequency characteristics of the filter are calculated by using the MTF indicating the amplitude component of the OTF instead of the OTF of [Expression 1] described above, and the coefficient values are selected such that the calculated frequency characteristics of the filter are closest to the desired Wiener frequency characteristics. Thus, amplitude restoration filters F3 for recovering the deterioration in the frequency characteristics are calculated. Similarly, the frequency characteristics of the filter are calculated by using the PTF indicating the phase component of the OTF instead of the OTF of [Expression 1] described above, and the coefficient values are selected such that the calculated frequency characteristics of the filter are closest to the desired Wiener frequency characteristics. Thus, phase correction filters F2 for recovering the deterioration in the phase characteristics are calculated. In this case, the amplitude restoration filters F3 and the phase correction filters F2 serve as the first restoration filters.

In order to restore the original subject image (point image) from the original image data Do (first image data) of the blurred image, the amplitude restoration process P12 using the amplitude restoration filters F3 is performed on the original image data Do. Thus, the amplitude of the point-asymmetric blurred image is restored, and the blurred image becomes small.

Subsequently, the non-linear tone correction process P13 (gamma-correction processing through a logarithm process) is performed on the first image data acquired after the amplitude restoration process. The tone (gamma) correction process is a process of non-linearly correcting the image data such that the image is naturally reproduced by a display device.

The phase correction process P14 using the phase correction filters F2 is performed on the first image data on which the tone correction process is performed. The point-asymmetric image moves depending on the frequency and is recovered to the point-symmetric image through the phase correction process P14. Accordingly, recovery image data Dr indicating an image (recovery image) closer to the original subject image (point image) is acquired.

The amplitude restoration filters F3 used in the amplitude restoration process P12 are acquired by a predetermined amplitude restoration filter calculation algorithm P22 from the point image information (PSF, OTF, or MTF) of the optical system corresponding to the imaging condition in a case where the original image data Do is acquired, and the phase correction filters F2 used in the phase correction process P14 are acquired by a predetermined phase correction filter calculation algorithm P23 from the point image information (PSF, OTF, or PTF) of the optical system corresponding to the imaging condition in a case where the original image data Do is acquired.

The amplitude restoration filters F3 or the phase correction filters F2 in the real space constituted by the N×M taps may be derived by performing Fourier inversion transform on frequency amplitude characteristics of a recovery filter or phase characteristics of the recovery filter in a frequency space. Accordingly, the amplitude restoration filters F3 or the phase correction filters F2 in the real space may be appropriately calculated by determining the amplitude restoration filters or the phase correction filters in the frequency space as the basis and specifying the number of taps constituting the amplitude restoration filters F3 or the phase correction filters F2 in the real space. Preferably, the number of N×M taps of the phase correction filters F2 is greater than the number of taps of the amplitude restoration filters F3 in order to properly perform the phase correction.

As stated above, in the present embodiment, the non-linear tone correction process P13 is performed on the first image data on which the amplitude restoration process P12 is performed, and the phase correction process P14 is performed on the first image data on which the non-linear tone correction process P13 is performed. Accordingly, in the present embodiment, the phase correction filters greatly spread spatially, and thus, a phenomenon in which an artifact (ringing) is caused around a saturated pixel easily occurs in the phase correction process. However, it is possible to prevent the artifact from being amplified due to the tone correction (the artifact from being greatly caused) by performing the phase correction after the tone correction. Similarly, in the present embodiment, a phenomenon in which color gradation is changed due to the phase correction may occur but it is possible to alleviate the phenomenon. Accurately, the phenomenon in which the color gradation is changed also occurs even though the phase correction is performed after the tone correction, but it is possible to further reduce the number of times of the phenomenon occurrence than in a case where the phase correction is performed before the tone correction. In the present embodiment, since the number of bits of the image data acquired after the tone correction is less than that of the image data acquired before the tone correction, it is possible to reduce the calculation load in a case where the phase correction using the phase correction filters of which the number of taps is relatively great is performed.

In the present embodiment, the order in which the amplitude restoration process P12 and the phase correction process P14 are performed may be changed. That is, the non-linear tone correction process P13 may be performed on the first image data on which the phase correction process P14 is performed, and the amplitude restoration process P12 may be performed on the first image data on which the non-linear tone correction process P13 is performed. Accordingly, in the present embodiment, since the phase correction is performed before the tone correction (before the frequency characteristics of the image are changed), it is possible to effectively perform the phase correction. Further, since the amplitude restoration is performed after the tone correction, overshoot or undershoot slightly occurring due to the amplitude restoration is not amplified (emphasized) due to the tone correction, and, thus, it is possible to prevent the artifact from being greatly caused.

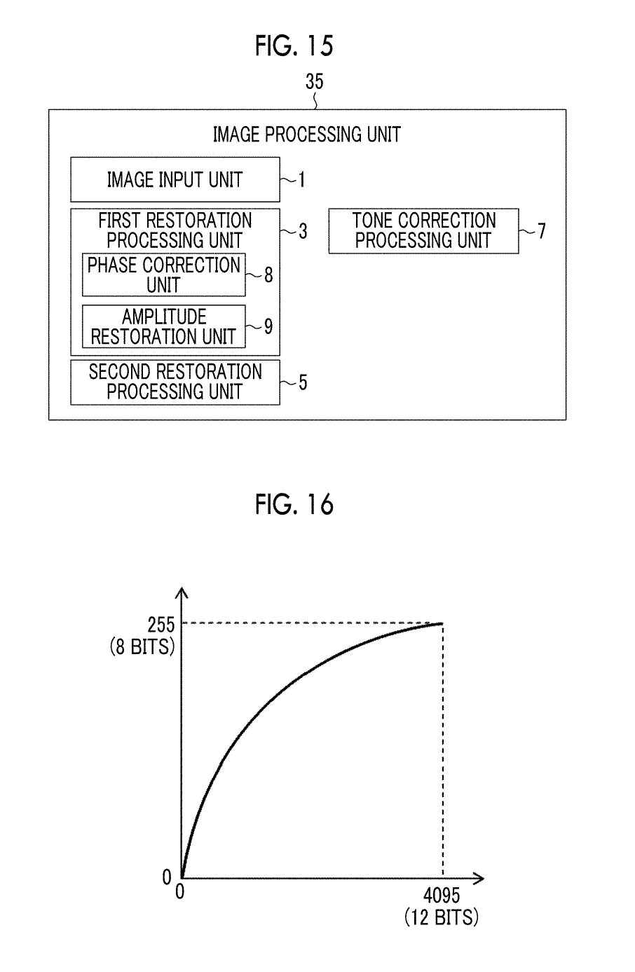

FIG. 15 is a block diagram showing a functional configuration example of the image processing unit 35 according to the second embodiment. The image processing unit 35 of the second embodiment includes the image input unit 1, the first restoration processing unit 3, the second restoration processing unit 5, and the tone correction processing unit 7. The components described in FIG. 7 will be assigned the same reference numerals, and the description thereof will be omitted.

The first restoration processing unit 3 includes a phase correction unit 8 and an amplitude restoration unit 9. The phase correction unit 8 performs the phase correction on the first image data, and the amplitude restoration unit 9 performs the amplitude restoration on the first image data.

The tone correction processing unit 7 is a part that performs the non-linear tone correction on the image data. For example, the tone correction processing unit performs the gamma-correction processing on the input RGB data items through the logarithm process, and performs a non-linear process on the RGB data items such that the image is naturally reproduced by the display device.

FIG. 16 is a graph showing an example of input and output characteristics (gamma characteristics) of the image data of which the tone is corrected by the tone correction processing unit 7. In the present example, the tone correction processing unit 7 performs the gamma correction corresponding to the gamma characteristics on the RGB data items of 12 bits (0 to 4,095), and generates the RGB color data items (1-byte data items) of 8-bit (0 to 255). For example, preferably, the tone correction processing unit 7 may be constituted by lookup tables (LUT) for RGB, and performs the gamma correction corresponding to the colors of the RGB data items. The tone correction processing unit 7 also performs a non-linear tone correction along a tone curve on the input data.

### Specific Example 1

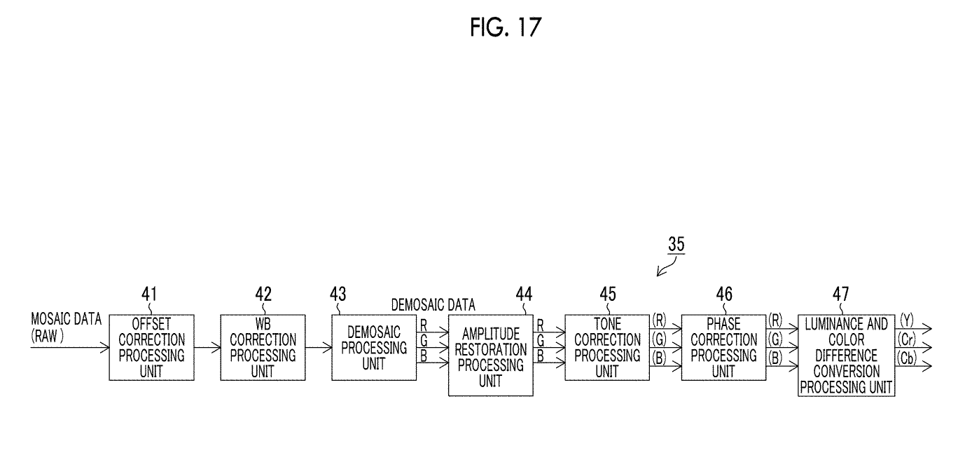

FIG. 17 is a block diagram showing an example (Specific Example 1) of a specific process of the image processing unit 35 according to the second embodiment.

The image processing unit 35 of the present example includes an offset correction processing unit 41, a WB correction processing unit 42 that adjusts white balance (WB), a demosaic processing unit 43, an amplitude restoration processing unit 44, a tone correction processing unit 45 including a gamma correction processing unit, a phase correction processing unit 46, and a luminance and color difference conversion processing unit 47 that is equivalent to one embodiment of a luminance data generation unit. The amplitude restoration process P12 described in FIG. 14 is performed in the amplitude restoration processing unit 44, and the phase correction process P14 described in FIG. 14 is performed in the phase correction processing unit 46.

In FIG. 17, mosaic data items (RAW data items: color data items (RGB data items) having a mosaic shape of red (R), green (G), and blue (B)), which are acquired before the image processing and are acquired from the imaging element 26, are dot-sequentially input to the offset correction processing unit 41. For example, the mosaic data items are data items (2-byte data per pixel) having a bit length of 12 bits (0 to 4,095) for RGB.

The offset correction processing unit 41 is a processing unit that corrects dark current components included in the input mosaic data items, and performs offset correction of the mosaic data items by subtracting signal values of optical black (OB) acquired from light-shielding pixels on the imaging element 26 from the mosaic data items.

The mosaic data (RGB data items) on which the offset correction is performed is applied to the WB correction processing unit 42. The WB correction processing unit 42 multiplies the RGB data items by WB gains set for the colors of RGB, and performs white balance correction of the RGB data items. For example, it is assumed that the type of the light source is automatically determined based on the RGB data items or the type of the light source is manually selected, the WB gain appropriate for the determined or selected type of the light source is set. The method of setting the WB gain is not limited thereto, and the WB gain may be set by another known method.

The demosaic processing unit 43 is a part that performs the demosaic process (referred to as a “synchronization process”) of calculating all color information items for pixels from a mosaic image corresponding to a color filter array of the imaging element 26 of a single plate type, and calculates, for example, all the color information items of RGB for pixels from the mosaic image including RGB in a case where the imaging element including the color filters of three RGB colors is used. That is, the demosaic processing unit 43 generates image data having three RGB surfaces synchronized from the mosaic data (dot-sequentially input RGB data items).

The RGB data items on which the demosaic process is performed are applied to the amplitude restoration processing unit 44, and the amplitude restoration process of the RGB data items is performed.

The RGB data items on which the amplitude restoration process is performed by the amplitude restoration processing unit 44 re applied to the tone correction processing unit 45.

The tone correction processing unit 45 is a part that performs the non-linear tone correction on the RGB data items on which the amplitude restoration process is performed. For example, the tone correction processing unit performs the gamma-correction processing on the input RGB data items through the logarithm process, and performs the non-linear process on the RGB data items such that the image is naturally reproduced by the display device.

(R) (G) (B) data items on which the tone correction is performed by the tone correction processing unit 45 are applied to the phase correction processing unit 46, and the phase correction process of the (R) (G) (B) data items is performed. The RGB data items acquired after the tone correction are described as (R) (G) (B) data items.

(R) (G) (B) data items on which the phase correction process is performed by the phase correction processing unit 46 are applied to the luminance and color difference conversion processing unit 47. The luminance and color difference conversion processing unit 47 is a processing unit that converts the (R) (G) (B) data items into color difference data items (Cr) and (Cb) and luminance data (Y) indicating the luminance component, and these data items may be calculated by the following expression.

(Y)=0.299(R)+0.587(G)+0.114(B)

(Cb)=−0.168736(R)−0.331264(G)+0.5(B)

(Cr) =−0.5(R)−0.418688(G)−0.081312(B) [Expression 2]

The (R) (G) (B) data items are 8-bit data items acquired after the tone correction and phase correction processes, and the luminance data (Y) and the color difference data items (Cr) and (Cb) converted from these (R) (G) (B) data items are also 8-bit data items. The conversion expression for converting the (R) (G) (B) data items into the luminance data (Y) and the color difference data items (Cr) and (Cb) is not limited to [Expression 2] described above.

For example, after a compression process such as the Joint Photographic coding Experts Group (JPEG) is performed on the 8-bit luminance data (Y) and color difference data items (Cr) and (Cb) converted in this manner, a plurality of associated data items such as header information, compressed main image data, and thumbnail image data is correlated with each other, and is formed as one image file.

### Specific Example 2

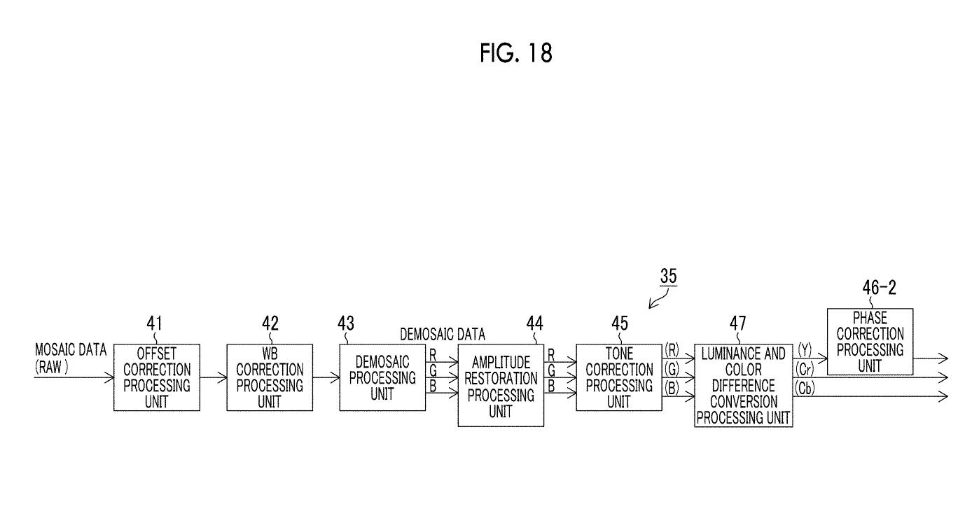

FIG. 18 is a block diagram showing an example (Specific Example 2) of a specific process of the image processing unit 35 according to the second embodiment. In FIG. 18, the components in common with the specific example of the image processing unit 35 shown in FIG. 17 will be assigned the same reference numerals, and the detailed description will be omitted.

A phase correction processing unit 46-2 of Specific Example 2 is mainly different from the phase correction processing unit 46 of Specific Example 1.

That is, the phase correction processing unit 46 of Specific Example 1 is provided in the latter stage of the tone correction processing unit 45 and performs the phase correction process on the (R) (G) (B) data items acquired after the tone correction, whereas the phase correction processing unit 46-2 of Specific Example 2 is provided in the latter stage of the luminance and color difference conversion processing unit 47 and performs the phase correction process on the luminance data (Y) (after the tone correction) converted by the luminance and color difference conversion processing unit 47.

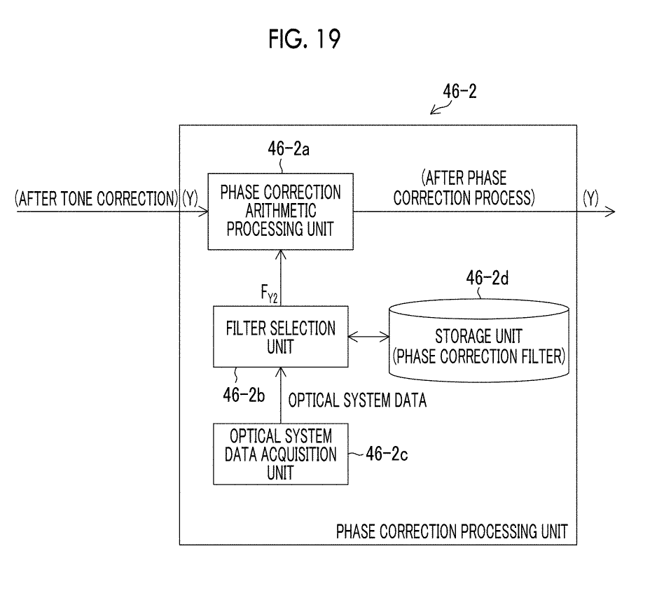

FIG. 19 is a block diagram showing a functional configuration example of the phase correction processing unit 46-2 of Specific Example 2.

The phase correction processing unit 46-2 shown in FIG. 19 includes a phase correction arithmetic processing unit 46-2a, a filter selection unit 46-2b, an optical system data acquisition unit 46-2c, and a storage unit 46-2d.

The filter selection unit 46-2b and the optical system data acquisition unit 46-2c respectively correspond to the filter selection unit 44b and the optical system data acquisition unit 44c shown in FIG. 7, and thus, the detailed description thereof will be omitted.

The storage unit 46-2d stores phase correction filters F_{Y2} which are generated based on the PSF, OTF, or PTF of multiple types of optical systems and correspond to the calculated luminance data from the first image data.

In this example, for example, the phase transfer functions (PTF_{R}, PTF_{G}, and PTF_{B}) of the RGB color channels may be mixed, the phase transfer function (PTF_{Y}) corresponding to the luminance data may be calculated, and the phase correction filters F_{Y2} corresponding to the luminance data may be generated based on the calculated PTF_{Y}. In a case where the PTF_{Y} is calculated, the PTF_{R}, PTF_{G}, and PTF_{B} are preferably calculated as a weighted linear sum. The same coefficient as the coefficient in a case where the luminance data (Y) is generated from the (R) (G) (B) data items shown in [Expression 2] is able to be used as a weighted coefficient, and the weighted coefficient is not limited thereto.

As another example of the phase correction filters F_{Y2} corresponding to the luminance data, the phase correction filters F_{G2} corresponding to the (G) data which contributes to generation of the luminance data (Y) the most as represented in [Expression 2] may be used as the phase correction filters F_{Y2}. Preferably, the storage unit 46-2d stores the phase correction filters F_{Y2} which respectively correspond to the stop value (F-number), the focal length, and the image height.

The filter selection unit 46-2b selects the phase correction filters corresponding to the optical system data of the optical system used in a case where the original image data (first image data) is imaged and acquired, among the phase correction filters stored in the storage unit 46-2d, based on the optical system data acquired by the optical system data acquisition unit 46-2c. The phase correction filters F_{Y2} which are selected by the filter selection unit 46-2b and correspond to the luminance data are sent to the phase correction arithmetic processing unit 46-2a.

The luminance data (Y) acquired after the tone correction (gamma correction) is input to the phase correction arithmetic processing unit 46-2a, and the phase correction arithmetic processing unit 46-2a performs the phase correction process using the phase correction filters F_{Y2} selected by the filter selection unit 46-2b on the luminance data (Y). That is, the phase correction arithmetic processing unit 46-2a performs the deconvolution arithmetic of the phase correction filters F_{Y2} and the luminance data (Y) (luminance data (Y) of the processing target pixels and the adjacent pixels) corresponding to the phase correction filters, and calculates the luminance data (Y) acquired after the phase correction process.

The phase correction processing unit 46-2 having the above-described configuration may perform the phase correction process in which the phase transfer function (PTF) of the luminance data (Y) is reflected on the luminance data (Y).

Since processing systems corresponding to three channels (3ch) are required in the phase correction process performed on the RGB data items by the phase correction processing unit 46 of Specific Example 1 (FIG. 17), but a processing system corresponding to one channel (1ch) is sufficient in the phase correction process performed on the luminance data (Y), it is possible to reduce a circuit size and a calculation load in the phase correction process performed on the luminance data, and it is possible to reduce the number of phase correction filters stored in the storage unit 46-2d.

In a case where the RGB data items are acquired in the phase correction process performed on the RGB data items as expected (like the point spread function information of the optical system), it is possible to perform an effective phase correction process on the RGB data items, and it is possible to more effectively reduce the chromatic aberration than in the phase correction process performed on the luminance data. However, in a case where an actual behavior of an input signal is not as expected, the number of locations in which unnecessary coloring is caused increases in the phase correction process performed on the RGB data items, and a side effect like a case where unnatural shade is remarkable may occur.

In contrast, since the phase correction processing unit 46-2 of Specific Example 2 (FIG. 18) performs the phase correction process on only the luminance data, an effect (color system toughness in coloring degree or blurring degree) that the above-described side effect hardly occur is acquired.

Since the phase correction process performed by the phase correction processing unit 46-2 is performed on the luminance data (Y) acquired after the tone correction (gamma correction), the phase correction processing unit of Specific Example 2 is the same as that of the phase correction processing unit 46 of Specific Example 1 in that it is possible to prevent the caused artifact from being emphasized due to the tone correction and it is also possible to alleviate the phenomenon in which the color gradation is changed due to the phase correction process.

### Specific Example 3

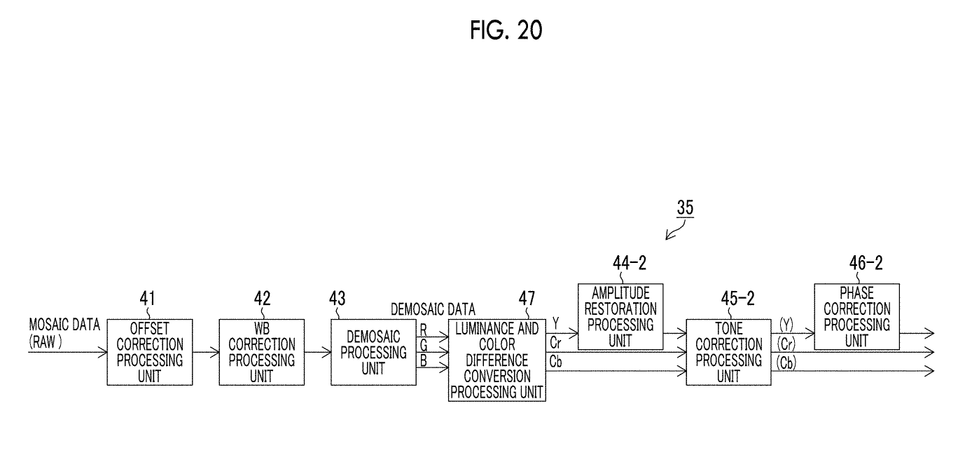

FIG. 20 is a block diagram showing an example (Specific Example 3) of a specific process of the image processing unit 35 according to the second embodiment. In FIG. 20, the components in common with the specific example of the image processing unit 35 shown in FIG. 17 will be assigned the same reference numerals, and the detailed description thereof will be omitted.

The amplitude restoration processing unit 44-2 of Specific Example 3 is mainly different from the amplitude restoration processing units 44 of Specific Example 1 and Specific Example 2.

That is, there is a difference in that the amplitude restoration processing units 44 of Specific Example 1 and Specific Example 2 are provided in the latter stage of the demosaic processing unit 43 and perform the amplitude restoration process on the R, G, and B demosaic data items, whereas the amplitude restoration processing unit 44-2 of Specific Example 3 is provided in the latter stage of the luminance and color difference conversion processing unit 47 and performs the amplitude restoration process on the luminance data Y (before the tone correction) converted by the luminance and color difference conversion processing unit 47.

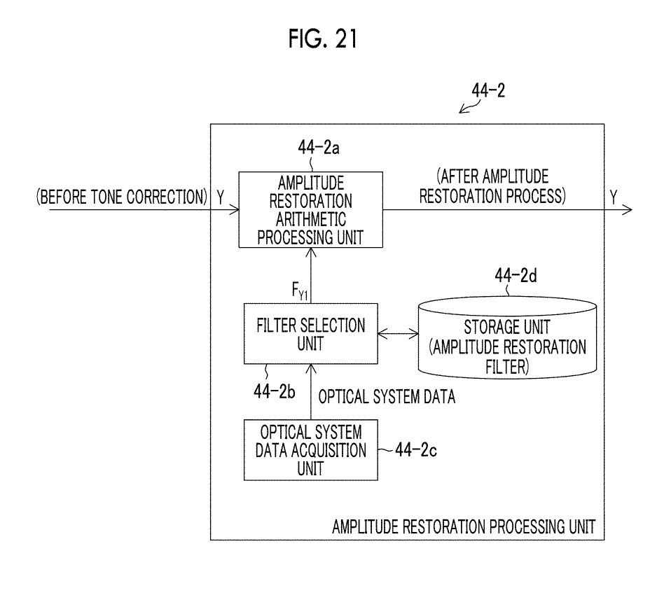

FIG. 21 is a block diagram showing a functional configuration example of the amplitude restoration processing unit 44 of Specific Example 3.

The amplitude restoration processing unit 44-2 shown in FIG. 21 includes an amplitude restoration arithmetic processing unit 44-2a, a filter selection unit 44-2b, an optical system data acquisition unit 44-2c, and a storage unit 44-2d.

Since the filter selection unit 44-2b and the optical system data acquisition unit 44-2c respectively correspond to the filter selection unit 44b and the optical system data acquisition unit 44c shown in FIG. 7, the detailed description thereof will be omitted.

The storage unit 44-2d stores amplitude restoration filters F_{Y1} which are generated based on the PSF, OTF, or MTF of multiple types of optical systems and correspond to the image data (hereinafter, referred to as “luminance data Y”) indicating the luminance component.

In this example, for example, the modulation transfer functions (MTF_{R}, MTF_{G}, and MTF_{B}) of the RGB color channels may be mixed, the modulation transfer function (MTF_{Y}) corresponding to the luminance data Y may be calculated, and the amplitude restoration filters F_{Y1} corresponding to the luminance data Y may be generated based on the calculated MTF_{Y}. In a case where the MTF 15 calculated, the MTF_{R}, MTF_{G}, and MTF_{B} are preferably calculated as a weighted linear sum. The same coefficient as the coefficient in a case where the luminance data (Y) is generated from the (R) (G) (B) data items represented in [Expression 2] is able to be used as a weighted coefficient, and the weighted coefficient is not limited thereto.

As another example of the amplitude restoration filters F_{Y1} corresponding to the luminance data Y, the amplitude restoration filters F_{G1} corresponding to the G color data which contributes to generation of the luminance data Y the most as represented in [Expression 2] may be used as the amplitude restoration filters F_{Y1}. Preferably, the storage unit 44-2d stores the amplitude restoration filters F_{Y1} which respectively correspond to the stop value (F-number), the focal length, and the image height.

The filter selection unit 44-2b selects the amplitude restoration filters corresponding to the optical system data of the optical system used in a case where the original image data is imaged and acquired, among the amplitude restoration filters stored in the storage unit 44-2d, based on the optical system data acquired by the optical system data acquisition unit 44-2c. The amplitude restoration filters F_{Y1} which are selected by the filter selection unit 44-2b and correspond to the luminance data Y are sent to the amplitude restoration arithmetic processing unit 44-2a.

The luminance data Y acquired before the tone correction (gamma correction) is input to the amplitude restoration arithmetic processing unit 44-2a from the luminance and color difference conversion processing unit 47, and the amplitude restoration arithmetic processing unit 44-2a performs the amplitude restoration process using the amplitude restoration filters F_{Y1} selected by the filter selection unit 44-2b on the luminance data Y. That is, the amplitude restoration arithmetic processing unit 44-2a performs the deconvolution arithmetic of the amplitude restoration filters F_{Y1} and the corresponding luminance data Y (luminance data Y of the processing target pixels and the adjacent pixels), and calculates the luminance data Y on which the amplitude restoration process is performed.

The amplitude restoration processing unit 44-2 having the above-described configuration may perform the amplitude restoration process in which the modulation transfer function (MTF) of the luminance data Y is reflected on the luminance data Y.

Since processing systems corresponding to three channels (3ch) are required in the amplitude restoration process performed on the RGB data items by the amplitude restoration processing units 44 of Specific Example 1 (FIG. 17) and Specific Example 2 (FIG. 18), but a processing system corresponding to one channel (1ch) is sufficient in the amplitude restoration process performed on the luminance data Y, it is possible to reduce a circuit size and a calculation load in the amplitude restoration process performed on the luminance data, and it is possible to reduce the number of amplitude restoration filters stored in the storage unit 44-2d.

In a case where the RGB data items are acquired in the amplitude restoration process performed on the RGB data items as expected (like the point spread function information of the optical system), it is possible to perform an effective point image restoration process on the RGB data items, and it is possible to more effectively reduce the chromatic aberration than in the amplitude restoration process performed on the luminance data. However, in a case where an actual behavior of an input signal is not as expected, the number of locations in which unnecessary coloring is caused increases in the amplitude restoration process performed on the RGB data items, and a side effect like a case where unnatural shade is remarkable may occur.

In contrast, since the amplitude restoration processing unit 44-2 of Specific Example 3 performs the amplitude restoration process on only the luminance data, an effect (color system toughness in coloring degree or blurring degree) that the above-described side effect hardly occurs is acquired.

Similarly to Specific Example 2, since the phase correction process performed by the phase correction processing unit 46-2 is performed on the luminance data (Y) acquired after the tone correction (gamma correction), the same effect as that of Specific Example 2 is acquired.

Since the image processing unit 35 of Specific Example 3 performs the amplitude restoration process on the luminance data Y acquired before the tone correction and performs the phase correction process on the luminance data (Y) acquired after the tone correction, it is possible to reduce the circuit size and the calculation load the most among Specific Example 1 to Specific Example 3.

Specific Example 3 shown in FIG. 20 is different from Specific Example 1 and Specific Example 2 in which the luminance and color difference conversion processing unit 47 converts the color data items (RGB) acquired before the tone correction into the luminance data Y and the color difference data items Cr and Cb and converts the (R) (G) (B) data items acquired after the tone correction into the luminance data (Y) and the color difference data items (Cr) and (Cb), but the processing contents of Specific Example 3 are the same as those of Specific Example 1 and Specific Example 2.

The tone correction processing units 45 of Specific Example 1 (FIG. 17) and Specific Example 2 (FIG. 18) performs the tone correction (gamma correction) on the RGB data items, whereas the tone correction processing unit 45-2 of Specific Example 3 performs the non-linear tone correction (gamma correction) on the luminance data Y on which the amplitude restoration process is performed by the amplitude restoration processing unit 44-2 and the color difference data items Cr and Cb converted by the luminance and color difference conversion processing unit 47. Thus, the tone correction processing unit of Specific Example 3 is different from the tone correction processing units 45 of Specific Example 1 and Specific Example 2. The luminance data Y and the color difference data items Cr and Cb input to the tone correction processing unit 45-2 are respectively 12-bit data items (2-byte data items), and the luminance data (Y) and the color difference data items (Cr) and (Cb) acquired after the tone correction are respectively converted into 8-bit data items (1-byte data items).

### Specific Example 4

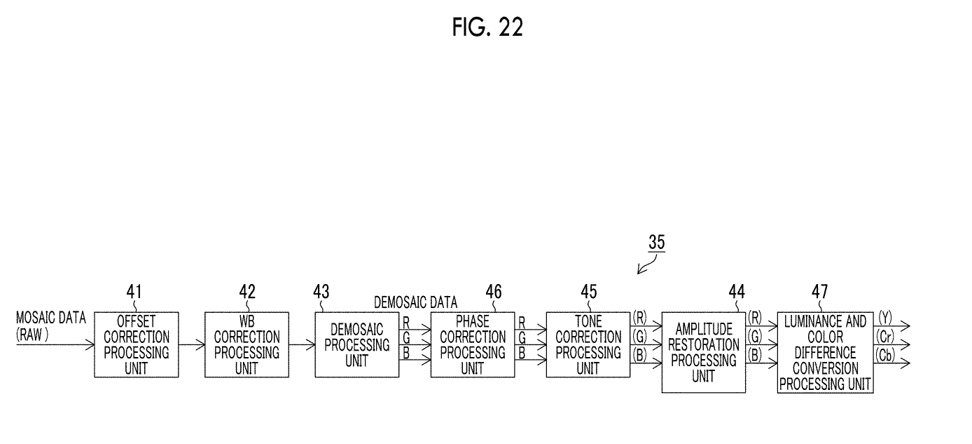

FIG. 22 is a block diagram showing an example (Specific Example 4) of a specific process of the image processing unit 35 according to the second embodiment. In FIG. 22, the components in common with the specific example of the image processing unit 35 shown in FIG. 17 will be assigned the same reference numerals, and the detailed description thereof will be omitted.

The image processing unit 35 of the present example includes the offset correction processing unit 41, the WB correction processing unit 42 that adjusts the white balance (WB), the demosaic processing unit 43, the phase correction processing unit 46, the tone correction processing unit 45 including the gamma correction processing unit, the amplitude restoration processing unit 44, and the luminance and color difference conversion processing unit 47 equivalent to one embodiment of the luminance data generation unit.

The RGB data items on which the demosaic process is performed in the demosaic processing unit 43 are applied to the phase correction processing unit 46, and the phase correction process of the RGB data items is performed.

### Specific Example 5

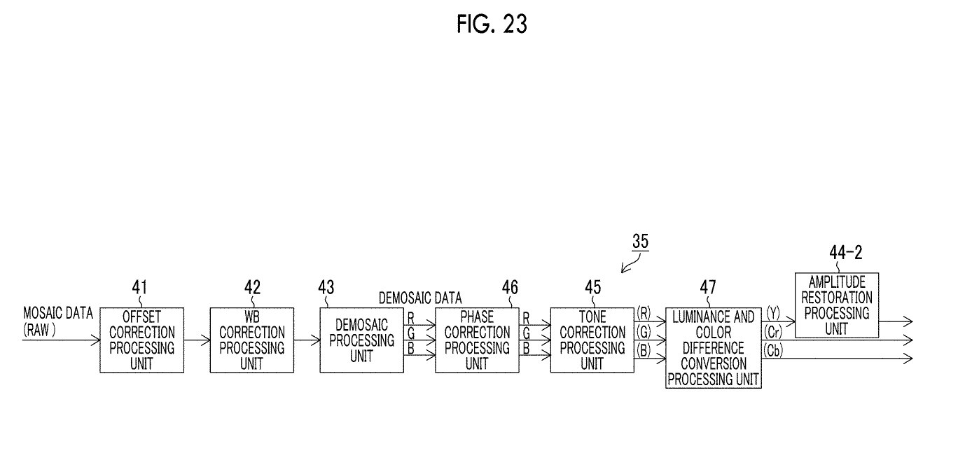

FIG. 23 is a block diagram showing an example (Specific Example 5) of the specific process of the image processing unit 35 according to the second embodiment. In FIG. 23, the components in common with the specific example of the image processing unit 35 shown in FIG. 17 will be assigned the same reference numerals, and the detailed description thereof will be omitted.

The amplitude restoration processing unit 44-2 of Specific Example 5 is mainly different from the amplitude restoration processing unit 44 of Specific Example 4.

That is, there is a difference in that the amplitude restoration processing unit 44 of Specific Example 4 is provided in the latter stage of the tone correction processing unit 45 and performs the amplitude restoration process on the (R) (G) (B) data items acquired after the tone correction, whereas the amplitude restoration processing unit 44-2 of Specific Example 5 is provided in the latter stage of the luminance and color difference conversion processing unit 47 and performs the amplitude restoration process on the luminance data (Y) (after the tone correction) converted by the luminance and color difference conversion processing unit 47.

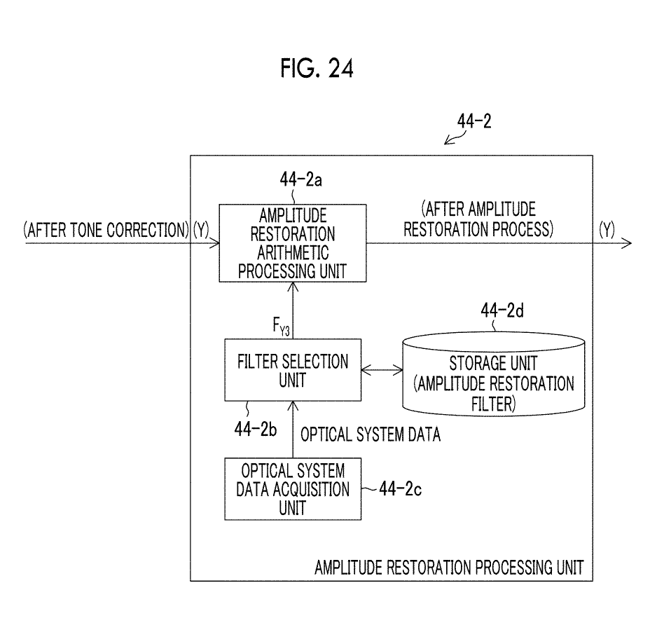

FIG. 24 is a block diagram showing a functional configuration example of the amplitude restoration processing unit 44-2 of Specific Example 5.

The amplitude restoration processing unit 44-2 shown in FIG. 24 includes the amplitude restoration arithmetic processing unit 44-2a, the filter selection unit 46-2b, the optical system data acquisition unit 46-2c, and the storage unit 46-2d.

The filter selection unit 46-2b and the optical system data acquisition unit 46-2c respectively correspond to the filter selection unit 44b and the optical system data acquisition unit 44c shown in FIG. 7, and thus, the detailed description thereof will be omitted.

The storage unit 46-2d stores amplitude restoration filters F_{Y3} which are generated based on the PSF, OTF, or MTF of multiple types of optical systems and correspond to the luminance data.

In this example, for example, the modulation transfer functions (MTF_{R}, MTF_{G}, and MTF_{B}) of the color channels of RGB may be mixed, the modulation transfer functions (MTF_{Y}) corresponding to the luminance data may be calculated, and the amplitude restoration filters F_{Y3} corresponding to the luminance data may be generated based on the calculated MTF_{Y}. In a case where the MTF 15 calculated, the MTF_{R}, MTF_{G}, and MTF_{B} are preferably calculated as a weighted linear sum. The same coefficient as the coefficient in a case where the luminance data (Y) is generated from the (R) (G) (B) data items shown in [Expression 2] is able to be used as a weighted coefficient, and the weighted coefficient is not limited thereto.

As another example of the amplitude restoration filters F_{Y3} corresponding to the luminance data, the amplitude restoration filters F_{G3} corresponding to the (G) data which contributes to generation of the luminance data (Y) the most as represented in [Expression 2] may be used as the amplitude restoration filters F_{Y3}. Preferably, the storage unit 46-2d stores the amplitude restoration filters F_{Y3} which respectively correspond to the stop value (F-number), the focal length, and the image height.

The filter selection unit 46-2b selects the amplitude restoration filters corresponding to the optical system data of the optical system used in a case where the original image data is imaged and acquired, among the amplitude restoration filters stored in the storage unit 46-2d, based on the optical system data acquired by the optical system data acquisition unit 46-2c. The amplitude restoration filters F_{Y3} which are selected by the filter selection unit 46-2b and correspond to the luminance data are sent to the amplitude restoration arithmetic processing unit 44-2a.

The luminance data (Y) after the tone correction (gamma correction) is input to the amplitude restoration arithmetic processing unit 44-2a, and the amplitude restoration arithmetic processing unit 44-2a performs the amplitude restoration process using the amplitude restoration filters F_{Y3} selected by the filter selection unit 46-2b on the luminance data (Y). That is, the amplitude restoration arithmetic processing unit 44-2a performs the deconvolution arithmetic of the amplitude restoration filters F_{Y3} and the corresponding luminance data (Y) (luminance data (Y) of the processing target pixels and the adjacent pixels), and calculates the luminance data (Y) acquired after the amplitude restoration process.

The amplitude restoration processing unit 44-2 having the above-described configuration may perform the amplitude restoration process in which the modulation transfer function (MTF) of the luminance data (Y) is reflected on the luminance data (Y).

Since processing systems corresponding to three channels (3ch) are required in the amplitude restoration process performed on the RGB data items by the amplitude restoration processing unit 44 of Specific Example 4 (FIG. 22), but a processing system corresponding to one channel (1ch) is sufficient in the amplitude restoration process performed on the luminance data (Y), it is possible to reduce a circuit size and a calculation load in the amplitude restoration process performed on the luminance data, and it is possible to reduce the number of amplitude restoration filters stored in the storage unit 46-2d.

In a case where the color data items of the RGB colors are acquired in the amplitude restoration process performed on the RGB data items as expected (like the point spread function information of the optical system), it is possible to perform an effective amplitude restoration process on the RGB data items. However, in a case where an actual behavior of an input signal is not as expected, the number of locations in which unnecessary coloring is caused increases in the amplitude restoration process performed on the RGB data items, and a side effect like a case where unnatural shade is remarkable may occur.

In contrast, since the amplitude restoration processing unit 44-2 of Specific Example 4 performs the amplitude restoration process on only the luminance data, an effect (color system toughness in coloring degree or blurring degree) that the above-described side effect hardly occurs is acquired.

Since the modulation restoration process performed by the amplitude restoration processing unit 44-2 is performed on the luminance data (Y) acquired after the tone correction (gamma correction), the amplitude restoration processing unit of Specific Example 5 is the same as the amplitude restoration processing unit 44 of Specific Example 4 in that it is possible to prevent the caused artifact from being emphasized due to the tone correction.

### Third Embodiment

Hereinafter, a third embodiment will be described.

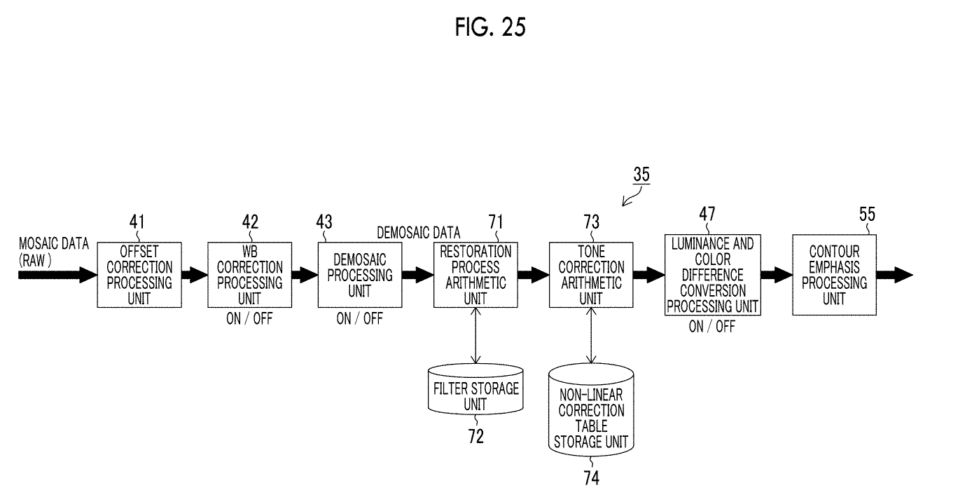

FIG. 25 is a block diagram showing an example of a specific process of the image processing unit 35 according to the third embodiment. In the image processing unit 35 according to the third embodiment, a common image processing circuit processes the image (first image data) of the visible light image and the image (second image data) of the near-infrared ray image. A visible light imaging mode is a mode in which the IR cut filter 25 is inserted into the imaging optical path of the optical system, the near-infrared ray is not emitted from the near-infrared ray emitting unit 15, and the imaging is performed in the daytime. A near-infrared ray imaging mode is a mode in which the IR cut filter 25 retreats from the imaging optical path of the optical system, the near-infrared ray is emitted from the near-infrared ray emitting unit 15, and the imaging is performed in the nighttime. The RGB data items (first image data) are acquired in a case where the imaging is performed in the visible light imaging mode, and the IR data (second image data) is acquired in a case where the imaging is performed in the near-infrared ray imaging mode.

The image processing unit 35 of the present example includes the offset correction processing unit 41, the WB correction processing unit 42 that adjusts the white balance (WB), the demosaic processing unit 43, a restoration process arithmetic unit 71, a restoration filter storage unit 72, a tone correction arithmetic unit 73, a non-linear correction table storage unit 74, the luminance and color difference conversion processing unit 47, and a contour emphasis processing unit 55.

The mosaic data items (RAW data items) which are acquired before the image processing and are acquired from the imaging element 26 are dot-sequentially input to the offset correction processing unit 41 in a case where the imaging is performed in the visible light imaging mode and the near-infrared ray imaging mode.

The offset correction processing unit 41 is a processing unit that corrects dark current components included in the input mosaic data items, and performs offset correction of the mosaic data items by subtracting signal values of optical black (OB) acquired from light-shielding pixels on the imaging element 26 from the mosaic data items.

The mosaic data items on which the offset correction is performed are applied to the WB correction processing unit 42. In a case where the image data (RGB data items) imaged in the visible light imaging mode is input, the WB correction processing unit 42 multiplies the RGB data items by the WB gains set for the RGB colors, and performs the white balance correction of the RGB data items. For example, it is assumed that the type of the light source is automatically determined based on the RGB data items or the type of the light source is manually selected, the WB gain appropriate for the determined or selected type of the light source is set. The method of setting the WB gain is not limited thereto, and the WB gain may be set by another known method. In a case where the image data (IR data) imaged in the near-infrared ray imaging mode is input, since it is not necessary to perform the WB correction, the WB correction processing unit 42 outputs the image data without performing the process in a case where the IR data is input. In a case where the IR data is input, the WB correction processing unit 42 may perform a process of adjusting an output value from a pixel having an R filter, an output value from a pixel having a G filter, and an output value from a pixel having a B filter.

In a case where the image data (RGB data items) imaged in the visible light imaging mode is input, the demosaic processing unit 43 calculates all color information items of RGB for the pixels from the mosaic image including RGB. That is, the demosaic processing unit 43 generates image data having three RGB surfaces synchronized from the mosaic data items (dot-sequentially input RGB data items). In a case where the image data (IR data) imaged in the near-infrared ray imaging mode is input, since the demosaic processing unit 43 does not need to perform the demosaic process, the demosaic processing unit 43 outputs the image data without performing the process. It is considered that it is not necessary to perform the demosaic process on the IR data since output sensitivity from the pixel having the R filter, output sensitivity from the pixel having the G filter, and output sensitivity from the pixel having the B filter are substantially equal to each other.

The RGB data items or the IR data output from the demosaic processing unit 43 are input to the restoration process arithmetic unit 71, and the first restoration process and the second restoration process are performed.

The restoration process arithmetic unit 71 has a function of performing the first restoration process and a function of performing the second restoration process. The restoration process arithmetic unit 71 selects the restoration filters stored in the restoration filter storage unit 72 depending on the input image data, and performs the arithmetic of the restoration process by using the selected restoration filters. Specifically, in a case where the image data (RGB data items) imaged in the visible light imaging mode is input, the restoration process arithmetic unit 71 selects the first restoration filters from the restoration filter storage unit 72, and performs the arithmetic of the first restoration process. In a case where the image data (IR data) imaged in the near-infrared ray imaging mode is input, the restoration process arithmetic unit 71 selects the second restoration filters from the restoration filter storage unit 72, and performs the arithmetic of the second restoration process. As stated above, the restoration process arithmetic unit 71 may perform the first restoration process and the second restoration process by changing the selection of the restoration filters stored in the restoration filter storage unit 72.

The RGB data items and the IR data on which the restoration process is performed by the restoration process arithmetic unit 71 are applied to the tone correction arithmetic unit 73.

The tone correction arithmetic unit 73 is a part that performs the non-linear tone correction on the RGB data items and the IR data. For example, the tone correction arithmetic unit 73 performs the gamma-correction processing on the input RGB data items and IR data through the logarithm process, and performs the non-linear process on the RGB data items such that the image is naturally reproduced by the display device. The tone correction arithmetic unit 73 acquires table data for performing the non-linear tone correction from the non-linear correction table storage unit 74 depending on the image data. In this example, table data for performing the non-linear tone correction on the R, G, and B data items and table data for performing the non-linear tone correction on the IR data are stored in the non-linear correction table storage unit 74.

The (R) (G) (B) data items on which the tone correction is performed by the tone correction arithmetic unit 73 and the IR data on which the tone correction is performed are applied to the luminance and color difference conversion processing unit 47.

The luminance and color difference conversion processing unit 47 is a processing unit that converts the (R) (G) (B) data items into the color difference data items (Cr) and (Cb) and the luminance data (Y) indicating the luminance component in a case where the image data imaged in the visible light imaging mode is input, and calculates these data items by the expression represented in [Expression 2]. In a case where the image data imaged in the near-infrared ray imaging mode is input, since the luminance and color difference conversion processing unit 47 does not need to convert the IR data on which the tone correction is performed into the luminance data (Y) and the color difference data items (Cr) and (Cb), the luminance and color difference conversion processing unit 47 outputs the IR data on which the tone correction is performed without performing the process.

The image data output from the luminance and color difference conversion processing unit 47 is input to the contour emphasis processing unit 55.

The contour emphasis processing unit 55 performs a contour emphasis process on the input data items (Y), (Cb), and (Cr) and the IR data on which the tone correction is performed. The contour emphasis processing unit 55 performs the contour emphasis process on the data (Y) in a case where the data items (Y), (Cb), and (Cr) are input, and performs the contour emphasis process on the IR data in a case where the IR data on which the tone correction is performed is input.

According to the present embodiment, since the common image processing circuit processes the image data imaged in the visible light imaging mode and the image data imaged in the near-infrared ray imaging mode, it is possible to reduce a design load of the circuit, and it is possible to reduce the size of the circuit.

### Application Example to EDoF System

The point image restoration process (amplitude restoration process and phase correction process) according to the above-described embodiments is the image processing for restoring the original subject image by performing the amplitude restoration process and the phase correction process on the point spread (point image blurring) depending on a specific imaging condition (for example, the stop value, the F-number, the focal length, and the lens type), and the image processing to which the present invention is applicable is not limited to the restoration process according to the above-described embodiments. For example, the restoration process according to the present invention may be applied to the restoration process performed on the image data imaged and acquired by the optical system (imaging lens) having an extended depth of field (focus) (EDoF). The restoration process is performed on the image data of the blurred image imaged and acquired in a state in which the depth of field (focal depth) is extended by the EDoF optical system, and thus, it is possible to restore and generate high-resolution image data which is in focus over a wide range. In this case, the restoration process using the amplitude restoration filters and the phase correction filters which are the amplitude restoration filters and the phase correction filters based on the transfer function (PSF, OTF, MTF, or PTF) of the EDoF optical system and have the filter coefficients set such that favorable image restoration is able to be performed in a range of the extended depth of field (focal depth) is performed.

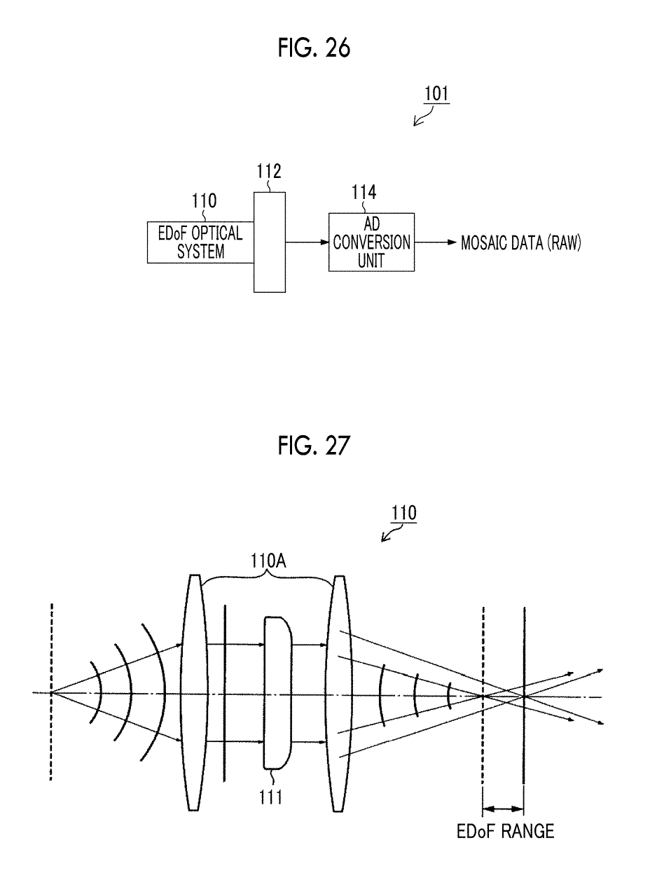

FIG. 26 is a block diagram showing an embodiment of an imaging module 101 including the EDoF optical system. The imaging module (a camera head mounted on the digital camera) 101 of the present example includes an EDoF optical system (lens unit) 110, an imaging element 112, and an analog-to-digital (AD) conversion unit 114.

FIG. 27 is a diagram showing an example of the EDoF optical system 110. The EDoF optical system 110 of the present example includes an imaging lens 110A having a fixed unifocal length and an optical filter 111 disposed in a pupil position. The optical filter 111 modulates the phase, and ensures the EDoF of the EDoF optical system 110 (imaging lens 110A) such that the extended depth of field (focal depth) (EDoF) is ensured. As stated above, the imaging lens 110A and the optical filter 111 constitute a lens unit that modulates the phase and extends the depth of field.

The EDoF optical system 110 includes another constituent element when necessary. For example, a stop (not shown) is provided around the optical filter 111. One optical filter 111 may be provided, or a plurality of optical filters may be combined. The optical filter 111 is merely an example of optical phase modulation means, and the EDoF of the EDoF optical system 110 (imaging lens 110A) may be ensured by another means. For example, instead of providing the optical filter 111, the EDoF of the EDoF optical system 110 may be ensured by the imaging lens 110A of which the lens is designed so as to have the same function as that of the optical filter 111 of the present example.

That is, the EDoF of the EDoF optical system 110 may be ensured by various means for changing an image forming wavefront on a light reception surface of the imaging element 112. For example, an “optical element of which a thickness is changed”, an “optical element (a refractive index distribution type wavefront modulation lens) of which a refractive index is changed”, an “optical element (a wavefront modulation hybrid lens or an optical element formed as a phase surface on the lens surface) of which a thickness or a refractive index is changed through coding on a lens surface”, and a “liquid crystal element (a liquid crystal spatial phase modulation element) capable of modulating the phase distribution of light” may be employed as means for ensuring the EDoF of the EDoF optical system 110. As stated above, in addition to a case where images which are regularly distributed by an optical wavefront modulation element (the optical filter 111 (a phase plate)) are able to be formed, the present invention may be applied to a case where the same distributed images as those in a case where the optical wavefront modulation element is used are able to be formed by the imaging lens 110A without using the optical wavefront modulation element.

Since a focus adjustment mechanism that mechanically performs focus adjustment may be omitted in the EDoF optical system 110 shown in FIGS. 26 and 27, it is possible to reduce a size of the EDoF optical system, and it is possible to appropriately mount the EDoF system on a mobile phone or a mobile information terminal with a camera.

An optical image that passes through the EDoF optical system 110 that acquires the EDoF is formed on the imaging element 112 shown in FIG. 26, and is converted into an electrical signal.

The same imaging element as the imaging element 26 shown in FIG. 1 may be employed as the imaging element 112.

The analog-to-digital conversion unit (AD conversion unit) 114 converts analog RGB image signals output to pixels from the imaging element 112 into digital RGB image signals. The digital image signals acquired by converting the analog image signals into the digital image signals by the AD conversion unit 114 are output as the mosaic data items (RAW image data items).

The image processing unit (image processing device) 35 shown in the above-described embodiments is applied to the mosaic data items output from the imaging module 101, and thus, it is possible to generate high-resolution recovery image data which is in focus over a wide range.

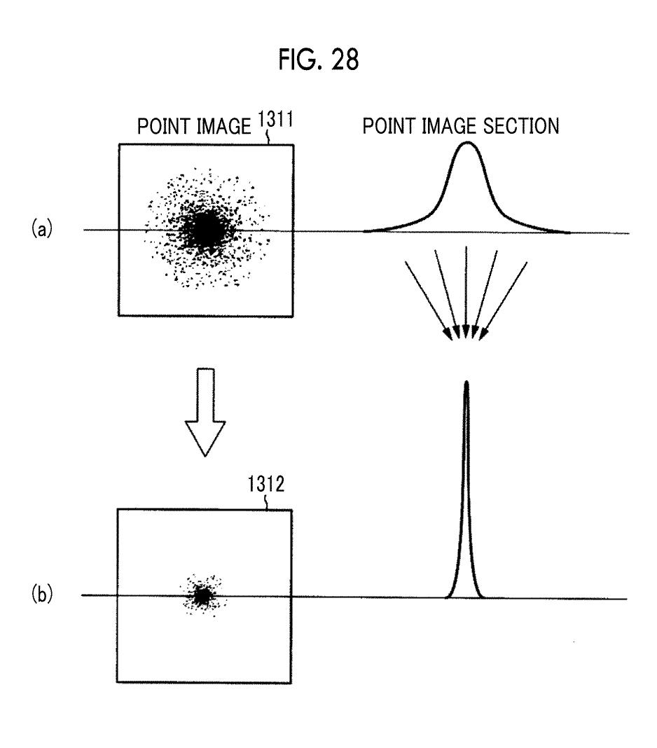

That is, as depicted by reference numeral 1311 of FIG. 28, the point image (optical image) that passes through the EDoF optical system 110 is formed as a large point image (blurred image) on the imaging element 112, but is restored as a small point image (high-resolution image) as depicted by 1312 of FIG. 28 by performing the point image restoration process (amplitude restoration process and phase correction process) by the image processing unit (image processing device) 35.

Although it has been described in the above-described embodiments that the image processing unit (image processing device) 35 is provided in the camera main body 14 (camera main body controller 28) of the digital camera 10, the image processing unit (image processing device) 35 may be provided in another device such as the computer 60 or the server 80.

For example, in a case where the image data is processed in the computer 60, the point image restoration process of this image data may be performed by the image processing unit (image processing device) 35 provided in the computer 60. For example, in a case where the server 80 includes the image processing unit (image processing device) 35, the image data may be transmitted to the server 80 from the digital camera 10 or the computer 60, and the point image restoration process may be performed on this image data in the image processing unit (image processing device) 35 of the server 80. The image data (recovery image data) acquired after the point image restoration process may be transmitted and provided to a transmission source.

While the examples of the present invention have been described above, the present invention is not limited to the above-described embodiments, and may be changed in various forms without departing from the spirit of the present invention.

### EXPLANATION OF REFERENCES

1: image input unit
3: first restoration processing unit
5: second restoration processing unit
7: tone correction processing unit
8: phase correction unit
9: amplitude restoration unit
10: digital camera
12: lens unit
14: camera main body
15: near-infrared ray emitting unit
16: lens
17: stop
18: optical system operation unit
19: subject
20: lens unit controller
22: lens-unit input and output unit
24: cut filter operation mechanism
25: IR cut filter
26: imaging element
28: camera main body controller
30: camera-main-body input and output unit
31: fluorescent lamp
32: input and output interface
33: IR floodlight
34: device control unit
35: image processing unit
60: computer
62: computer input and output unit
64: computer controller
66: display
70: Internet
80: server
82: server input and output unit
84: server controller
101: imaging module
110: EDoF optical system
110A: imaging lens
111: optical filter
112: imaging element
114: AD conversion unit

What is claimed is:

1. An image processing device comprising:
an image input unit that receives first image data indicating a visible light image imaged with sensitivity to a visible light wavelength band by using an optical system, and second image data indicating a near-infrared ray image imaged with sensitivity to a near-infrared ray wavelength band by using the optical system;
a first restoration processing unit that performs a first restoration process using first restoration filters for performing phase correction and amplitude restoration on the received first image data, the first restoration filters being based on a point spread function for visible light of the optical system; and
a second restoration processing unit that performs a second restoration process using second restoration filters for performing amplitude restoration without phase correction on the received second image data, the second restoration filters being based on a point spread function for a near-infrared ray of the optical system.

2. The image processing device according to claim 1, wherein:
the first image data is image data having a plurality of colors that includes a first color which contributes to acquisition of luminance data the most and two or more second colors other than the first color; and
the first restoration processing unit performs the first restoration process using the first restoration filters corresponding to the colors of the plurality of colors on the image data having the plurality of colors.

3. The image processing device according to claim 1, further comprising a tone correction processing unit that performs non-linear tone correction on the first image data, wherein:
the tone correction processing unit performs the non-linear tone correction on the first image data on which the phase correction is performed; and
the first restoration processing unit performs the amplitude restoration on the first image data on which the non-linear tone correction is performed.

4. The image processing device according to claim 1, further comprising a tone correction processing unit that performs non-linear tone correction on the first image data, wherein:
the tone correction processing unit performs the non-linear tone correction on the first image data on which the amplitude restoration is performed; and
the first restoration processing unit performs the phase correction on the first image data on which the non-linear tone correction is performed.

5. The image processing device according to claim 1, further comprising at least one of a common restoration process arithmetic unit that is used in a restoration process arithmetic of the first restoration processing unit and the second restoration processing unit, a common tone correction arithmetic unit that performs non-linear tone correction on the first image data and the second image data, or a common contour emphasis processing unit that performs a contour emphasis process on the first image data and the second image data.

6. The image processing device according to claim 1, further comprising a storage unit that stores the first restoration filters and the second restoration filters.

7. The image processing device according to claim 1, further comprising a filter generation unit that generates the first restoration filters and the second restoration filters.

8. An image processing device comprising:
an image input unit that receives first image data imaged by using an optical system in which an infrared cut filter is inserted into an imaging optical path, and second image data imaged by using the optical system in which the infrared cut filter retreats from the imaging optical path;
a first restoration processing unit that performs a first restoration process using first restoration filters for performing phase correction and amplitude restoration on the received first image data, the first restoration filters being based on a point spread function of the optical system; and
a second restoration processing unit that performs a second restoration process using second restoration filters for performing amplitude restoration without phase correction on the received second image data, the second restoration filters being based on a point spread function of the optical system.

9. The image processing device according to claim 8, wherein:
the first image data is image data having a plurality of colors that includes a first color which contributes to acquisition of luminance data the most and two or more second colors other than the first color; and
the first restoration processing unit performs the first restoration process using the first restoration filters corresponding to the colors of the plurality of colors on the image data having the plurality of colors.

10. The image processing device according to claim 8, further comprising a tone correction processing unit that performs non-linear tone correction on the first image data, wherein:
the tone correction processing unit performs the non-linear tone correction on the first image data on which the phase correction is performed; and
the first restoration processing unit performs the amplitude restoration on the first image data on which the non-linear tone correction is performed.

11. The image processing device according to claim 8, further comprising a tone correction processing unit that performs non-linear tone correction on the first image data, wherein:
the tone correction processing unit performs the non-linear tone correction on the first image data on which the amplitude restoration is performed; and
the first restoration processing unit performs the phase correction on the first image data on which the non-linear tone correction is performed.

12. The image processing device according to claim 8, further comprising at least one of a common restoration process arithmetic unit that is used in a restoration process arithmetic of the first restoration processing unit and the second restoration processing unit, a common tone correction arithmetic unit that performs non-linear tone correction on the first image data and the second image data, or a common contour emphasis processing unit that performs a contour emphasis process on the first image data and the second image data.

13. The image processing device according to claim 8, further comprising a storage unit that stores the first restoration filters and the second restoration filters.

14. The image processing device according to claim 8, further comprising a filter generation unit that generates the first restoration filters and the second restoration filters.

15. An imaging device comprising:
an optical system;
a cut filter operation mechanism that inserts or retreats an infrared cut filter into or from an imaging optical path of the optical system;
an image acquisition unit that acquires first image data imaged by using the optical system in which the infrared cut filter is inserted into the imaging optical path and second image data imaged by using the optical system in which the infrared cut filter retreats from the imaging optical path;
a first restoration processing unit that performs a first restoration process using first restoration filters for performing phase correction and amplitude restoration on the acquired first image data, the first restoration filters being based on a point spread function of the optical system; and
a second restoration processing unit that performs a second restoration process using second restoration filters for performing amplitude restoration without phase correction on the acquired second image data, the second restoration filters being based on a point spread function of the optical system.

16. The imaging device according to claim 15, wherein an image surface position is set by using a case where the image acquisition unit acquires the first image data as a criterion.

17. An image processing method comprising:
an image input step of receiving first image data imaged by using an optical system in which an infrared cut filter is inserted into an imaging optical path and second image data imaged by using the optical system in which the infrared cut filter retreats from the imaging optical path;
a first restoration processing step of performing a first restoration process using first restoration filters for performing phase correction and amplitude restoration on the received first image data, the first restoration filters being based on a point spread function of the optical system; and
a second restoration processing step of performing a second restoration process using second restoration filters for performing amplitude restoration without phase correction on the input second image data, the second restoration filters being based on a point spread function of the optical system.

18. A non-transitory computer-readable tangible medium containing a program causing a computer to perform:
an image input step of receiving first image data imaged by using an optical system in which an infrared cut filter is inserted into an imaging optical path and second image data imaged by using the optical system in which the infrared cut filter retreats from the imaging optical path;
a first restoration processing step of performing a first restoration process using first restoration filters for performing phase correction and amplitude restoration on the received first image data, the first restoration filters being based on a point spread function of the optical system; and
a second restoration processing step of performing a second restoration process using second restoration filters for performing amplitude restoration without phase correction on the input second image data, the second restoration filters being based on a point spread function of the optical system.
